(19) United States
(12) Patent Application Publication
(10) Pub. No.: US 2026/0082154 A1
(43) Pub. Date: Mar. 19, 2026

(54) SYSTEM AND METHOD FOR USE OF CENTER CHANNEL TO CREATE HEIGHT VIA NULL FORMING

(71) Applicant: Sound United, LLC, Carlsbad, CA (US)

(72) Inventor: Brian Cox, Henderson, NV (US)

(21) Appl. No.: 19/329,444

(22) Filed: Sep. 15, 2025

Related U.S. Application Data
(60) Provisional application No. 63/695,151, filed on Sep. 16, 2024.

(51) Int. Cl. H04R 5/02; G06F 3/16; H04S 7/00

(52) U.S. Cl. CPC H04R 5/02; G06F 3/16; H04S 7/302; H04R 2205/024; H04S 2400/05

(57) ABSTRACT

A loudspeaker system includes a three-loudspeaker array and signal processing method for rendering and playing audio content in a listening environment. The three-loudspeaker array includes a left loudspeaker element, a center/height loudspeaker element, and a right loudspeaker element. A signal processor/renderer can be programmed or configured to process input audio content with a plurality of (e.g., at least five) playback channels (e.g., left, center, right, left elevation, and right elevation channels). The right loudspeaker can be driven by a right main signal and a right elevation-cancellation signal, and/or a combined signal thereof. The left loudspeaker can be driven by a left main signal and a left elevation-cancellation signal, and/or a combined signal thereof. The center/height loudspeaker can be driven by a combination of a center main signal and an elevation/height signal derived or rendered from the input audio signal.

### CROSS-REFERENCE TO RELATED APPLICATIONS

This application claims the benefit under 35 U.S.C. § 119(e) of U.S. Provisional Patent Application No. 63/695,151 , filed Sep. 16, 2024, and titled SYSTEM AND METHOD FOR USE OF CENTER CHANNEL TO CREATE HEIGHT VIA NULL FORMING. The entirety contents of each of the above-identified application(s) are hereby incorporated by reference herein and made part of this specification for all that they disclose.

### REFERENCE TO SUBJECT-MATTER RELATED APPLICATIONS

The subject matter described in this application is related in some aspects to (a) U.S. patent application Ser. No. 17/436,932, entitled “Active Cancellation of a Height-Channel Soundbar Array's Forward Sound Radiation,” issued on Mar. 19, 2024 as U.S. Pat. No. 11,937,066, (b) U.S. patent application Ser. No. 15/796,303, issued on Jun. 18, 2019 as U.S. Pat. No. 10,327,064, entitled “Method and System for implementing Stereo Dimensional Array signal processing in a Compact Single Enclosure Active Loudspeaker Product”, (c) U.S. patent application Ser. No. 14/563,508, issued on Jun. 21, 2016 as U.S. Pat. No. 9,374,640, entitled “Method and System for Optimizing Center Channel Performance in a Single Enclosure Multi-Element Loudspeaker Line Array”, and (d) U.S. patent application Ser. No. 17/294,365, published on Dec. 30, 2021 as U.S. Patent Application Publication No. 2021/0409866, entitled “Loudspeaker System with Overhead Sound Image Generating (e.g., ATMOS™) Elevation Module and Method and apparatus for Direct Signal Cancellation” and (e) U.S. patent application Ser. No. 18/347,507, published on Mar. 7, 2024 as U.S. Patent Application Publication No. 2024/0080594, entitled “Speakers”, the entire contents of which are incorporated herein by reference for all that they disclose.

The subject matter of this application is also related in some aspects to the following: (a) U.S. patent application Ser. No. 06/383,151, issued on Dec. 18, 1984 as U.S. Pat. No. 4,489,432, entitled “METHOD AND APPARATUS FOR REPRODUCING SOUND HAVING A REALISTIC AMBIENT FIELD AND ACOUSTIC IMAGE”, (b) U.S. patent application Ser. No. 06/405,341, issued on Jan. 29, 1985 as U.S. Pat. No. 4,497,064, entitled “METHOD AND APPARATUS FOR REPRODUCING SOUND HAVING AN EXPANDED ACOUSTIC IMAGE”, (c) U.S. patent application Ser. No. 06/616,249, issued on Feb. 4, 1986 as U.S. Pat. No. 4,569,074, entitled “METHOD AND APPARATUS FOR REPRODUCING SOUND HAVING A REALISTIC AMBIENT FIELD AND ACOUSTIC IMAGE”, (d) U.S. patent application Ser. No. 10/692,692, issued on Aug. 30, 2005 as U.S. Pat. No. 6,937,737, entitled “MULTI-CHANNEL AUDIO SURROUND SOUND FROM FRONT LOCATED LOUDSPEAKERS”, (e) U.S. patent application Ser. No. 11/147,447, issued on Jun. 12, 2007 as U.S. Pat. No. 7,231,053, entitled “ENHANCED MULTI-CHANNEL AUDIO SURROUND SOUND FROM FRONT LOCATED LOUDSPEAKERS”, (f) U.S. patent application Ser. No. 13/295,972, issued on Nov. 10, 2015 as U.S. Pat. No. 9,185,490, entitled “SINGLE ENCLOSURE SURROUND SOUND LOUDSPEAKER SYSTEM AND METHOD”, and (g) PCT Patent Application No. PCT/US2020/021745, entitled “ACTIVE CANCELLATION OF A HEIGHT-CHANNEL SOUNDBAR ARRAY'S FORWARD SOUND RADIATION”, and published on Sep. 10, 2020 as PCT Patent Application Publication No. WO 2020/181288, the entire contents of which are incorporated herein by reference for all that they disclose.

### BACKGROUND

### Field of the Disclosure

Some embodiments relate generally to reproduction of sound in multichannel sound systems, such as “stereo” or “home theater” systems, and more specifically to multi-driver loudspeaker systems configured for use in a listening space.

### Description of the Related Art Although some multichannel audio systems exist, there remains a need for improved multichannel audio system.

### SUMMARY

Certain example aspects of the present disclosure are summarized below for illustrative purposes. The disclosure is not limited to the specific implementations recited herein. Aspects of the disclosure may include several novel features, no single one of which is solely responsible for its desirable attributes. This Summary is provided to introduce a selection of representative concepts in a simplified form, which representative concepts are further described below in the Detailed Description. This Summary section is not intended to identify limiting key features or essential features, nor is it intended to be used to limit the scope of the claims.

An improved and economical audio playback loudspeaker system may be configured in a single enclosure and can include signal processing circuitry programmed to implement a signal processing method for reproducing a wider variety of audio program material with satisfying sound optimized for (a) an individual listener in their sweet spot or (b) groups of listeners in a room having a variety of standing or seating spaces, where each listener may desire spacious sound (e.g., for a party) for music playback with or without height channel reproduction, for example, the system may be selectable for either party mode or single listener mode (e.g., for a listener seated in a listening position). The single listener mode can optimize the output sound for a specific listening position. Multiple listeners can use the system in single listener mode, and the output sound can be more optimized for those listeners sitting closer to the optimized listening position. The audio playback system can be configured with left, right and center/height channel speakers to render and play audio content in a user's listening environment with a selectable amount of height channel and center channel content. By adding a single Center/Height loudspeaker to a stereo (e.g., Left and Right) pair of loudspeakers, the users or listeners can be given many options. The system may be configured as an all in one or single enclosure smart speaker system (e.g., superficially resembling smart speaker 120) that can be used either in a home theater mode (e.g., reproducing height channel enveloping audio) or a music/audio reproduction mode, which can be further adjustable to provide a “sweet spot” listening mode or a casual listening even coverage (“party”) mode. In an example embodiment, the left and right speakers are aimed forwardly in a substantially horizontal listening plane aimed at the listening position 24, while the center/height speaker is positioned between them and aimed upwardly at a selected acute C/H aiming angle (e.g. 20 to 60 degrees) with respect to the horizontal listening plane, such as toward the ceiling.

The system and method can allow height channel signals (e.g., left height or elevation signals and right height or elevation signals) to be played back by a three speaker L-C/H-R array, by adding just the single C/H speaker to a stereo (e.g., L, R) pair, without the need to add dedicated left and right Height (H) channel speakers. Accordingly, two additional channels (e.g., left elevation and right elevation) can be added to the system by adding one additional speaker or driver (e.g., the center speaker between the left and right speakers). In some embodiments, the system does so by forming a “null” in vicinity of the listening position 24 where H content is cancelled, greatly accentuating the sound coming from above (e.g., from the ceiling), as perceived by the listener. By adjusting the timing of the signals transmitted to the L, C/H, and R array speakers or elements, the system also allows the user to select and control or aim the angle of the null, in order to get the best effect for their listening setup.

The system can include at least a right loudspeaker element (R), a left loudspeaker element (L), and a center/height (C/H) loudspeaker element, each receiving signals from a signal processor or renderer. The renderer can be configured to receive and process audio content and associated meta data specifying one or more playback locations of the audio content in the listening environment, and to output audio signals for each loudspeaker in the array. In some embodiments, the signal processor or renderer receives spatial or 3-D immersive audio system (e.g., Atmos™) meta data which can be used to generate five or seven channels of input signals, including, for example, a left or left front channel signal (“L”), a left elevation or height channel signal (“Le”), a center channel signal (“C”), a right or right front channel signal (“R”), and a right elevation or height channel signal (“Re”). The renderer and related signal processing circuitry can generate three distinct output signals from those five channels of input signals. Those three output signals comprise a first audio signal to drive the right loudspeaker element (R), a second audio signal to drive the left loudspeaker element (L), and a third audio signal to drive the center/height (C/H) loudspeaker element. In some embodiments, the system can also use the meta date to generate at least one right surround (e.g., side and/or rear) signal (“Rs”) and/or at least one left surround (e.g., side and/or rear) signal (“Ls”).

The signal processor or renderer can be operatively connectable to a compact three loudspeaker array including a right loudspeaker, a left loudspeaker, and a center/height loudspeaker configured to be positioned between the right loudspeaker and the left loudspeaker for rendering audio content for play in the listening environment. The signal processor or renderer can include at least memory storing instructions (e.g., on non-transitory computer media) and/or a processor configured and programmed to execute the instructions (e.g., on non-transitory computer media) to process audio content and associated meta data specifying one or more playback locations of the audio content in the listening environment, and to output one or more audio signals.

In some example embodiments, the system can receive a left channel signal (“L”), a left elevation or height channel signal (“Le”), a center channel signal (“C”), a right channel signal (“R”), and a right elevation or height channel signal (“Re”). The left speaker can reproduce a signal based on at least L and Le (e.g., L−(Le, which can be delayed, such as by Xms), while the right speaker can reproduces a signal based on at least R and Re (e.g., R−(Re, which can be delayed, such as by Xms), and the center speaker can reproduce a signal comprising two portions, namely (C (e.g., not delayed)) plus a height signal, which can be defined as H=(sum Le+Re, which can be delayed, such as by Xms). The center speaker can reproduce a signal based on at least C, Le, and Re. This configuration and signal processing method can generate convincing apparent height or elevation sound images above the listener, whereby height channel signals are played back through an L-C/H-R array, without the need to add dedicated elevation or height (H) channel speakers. The system can do so by forming a “null,” such as in vicinity of the listener, where H content is cancelled, greatly accentuating the sound which seems to come from above (e.g., from the ceiling). By adjusting the timing of the array elements (e.g., the Xms delays), the system can also allow for user control over the angle of the sound projections forming the null, such as in order to get the best effect for their listening setup. While this example mentions five channel home theater embodiments, the null forming technique can be readily adapted for use with a range of decoded or upmixed channel configurations. In some cases, the audio system can include a subwoofer, or other driver for producing sound based on a low-frequency effects signal (“LFE”). For example, L,C,R+LFE+Le,Re can be processed to provide a 3.1.2 embodiment and other configurations (e.g., 5.1.2, 7.1.2, 5.1.1 etc.) could all benefit. In some cases, the system can use at least one right surround (e.g., side and/or rear) signal (“Rs”) and/or at least one left surround (e.g., side and/or rear) signal (“Ls”). In some embodiments, the center channel signal C can be omitted. For example, the center speaker can be driven by a signal based on Le and Re, for example without a center channel signal.

A loudspeaker system can be configured to allow a user to listen to 3-D immersive audio content in a variety of user selectable modes includes a three-loudspeaker array and signal processing method for rendering and playing audio content in a listening environment. The three-loudspeaker array includes a left loudspeaker element, a center/height loudspeaker element, and a right loudspeaker element. A signal processor/renderer can be programmed or configured to process input audio content and associated meta data specifying a plurality of (e.g., at least five) playback locations or channels of the input audio content (e.g., left, center, right, left elevation, and right elevation channels). The system can generate three audio signals which can provide the user at least three user selectable listening experiences or modes, namely (a) an immersive 3-D listening experience, (b) a sweet spot music listening experience or (c) a “party mode” casual listening experience. In one example, the right loudspeaker (e.g., 204) is driven by a right-channel main signal and a right-channel elevation-cancellation signal, and/or a combined signal thereof. The left loudspeaker (e.g., 202) is driven by a left-channel main signal and a left-channel elevation-cancellation signal, and/or a combined signal thereof; and the center/height loudspeaker (e.g., 206) is selectively driven by a combination of a center main signal and a delayed elevation/height signal derived or rendered from the input audio signal.

Various aspect of the disclosure can relate to a loudspeaker system, which can include a left speaker; a right speaker; a center speaker positioned between the left speaker and the right speaker and aimed generally upward; and a signal processor, which can be configured to: receive a left audio signal (L); receive a right audio signal (R); receive a center audio signal (C); receive a left elevation audio signal (Le); receive a right elevation audio signal (Re); generate a left speaker signal that comprises the left audio signal and the left elevation audio signal; generate a right speaker signal that comprises the right audio signal and the right elevation audio signal; generate a center speaker signal that comprises the center audio signal, an inverted instance of the left elevation audio signal, and an inverted instance of the right elevation audio signal; drive the left speaker using the left speaker signal (L+Le); drive the right speaker using the right speaker signal (R+Re); and drive the center speaker using the center speaker signal (C−Le−Re).

The loudspeaker system can be configured to use the sounds produced by the left elevation audio signal and the right elevation audio signal to at least partially cancel sounds produced by the inverted instance of the left elevation audio signal and the inverted instance of the right elevation audio signal at a null. The signal processor can be configured to apply a first delay to the inverted instance of the left elevation audio signal and the inverted instance of the right elevation audio signal that are used to drive the center speaker. The signal processor can be configured to apply a second delay to the left elevation audio signal used to drive the left speaker and to apply the second delay the right elevation audio signal used to drive the right speaker. The signal processor can be configured to adjust a relative delay between the first delay and the second delay to move the null. The loudspeaker system can be configured to receive user input and to adjust the relative delay to move the null based on the user input. The loudspeaker system can be configured to automatically move the null towards a listening position. The loudspeaker system can be configured to transition to a different operating mode in which the signal processor is configured to: drive the left speaker using the left audio signal, the right audio signal, the center audio signal, the left elevation audio signal, and the right elevation audio signal; drive the right speaker using the left audio signal, the right audio signal, the center audio signal, the left elevation audio signal, and the right elevation audio signal; and drive the center speaker using the left audio signal, the right audio signal, the center audio signal, the left elevation audio signal, and the right elevation audio signal. The loudspeaker system can be configured to receive user input and to transition to the different operating mode in response to the user input. The loudspeaker system can include a housing or enclosure that supports the left speaker, the right speaker, and the center speaker.

Various aspect of the disclosure can relate to a method for playing multi-channel audio content in a listening environment. The method can include receiving left audio signals; receiving right audio signals; receiving center audio signals; receiving left elevation audio signals; receiving right elevation audio signals; inverting the left and right elevation audio signals to produce inverted left and right elevation audio signals; generating center combined audio signals using the center audio signals and the inverted left and right elevation audio signals; generating left combined audio signals using the left audio signals and the left elevation audio signals; generating right combined audio signals using the right audio signals and the right elevation audio signals; driving a center loudspeaker using the center combined audio signals, so that sounds produced by the inverted left and right elevation audio signals are directed upward to bounce off the ceiling and approach a listening location from above, and wherein direct sounds produced by the inverted left and right elevation signals travel directly from the center loudspeaker to the listening location; and driving a left loudspeaker using the left combined audio signals and driving a right loudspeaker using the right combined audio signals, so that sounds produced by the left elevation audio signals and the right elevation audio signals at least partially cancel the direct sounds produced by the inverted left and right elevation audio signals at the listening location.

The method can include applying a first delay to the inverted left and right elevation audio signals used to drive the center loudspeaker. The method can include applying a second delay to the left elevation audio signals used to drive the left loudspeaker, and applying the second delay to the right elevation audio signals used to drive the right loudspeaker. The method can include changing the relative delay between the first delay and the second delay to move an area of destructive interference between the sounds produced by the inverted left and right elevation audio signals and the sounds produced by the right elevation audio signals and the left elevation audio signals. The method can include receiving a user command via a user interface, and changing the relative delay in response to the user command to move the area of destructive interference. The method can include positioning a microphone at the listening position and adjusting the relative delay based at least in part on sounds measured by the microphone at the listening position. The method can include transitioning to a different mode of operation, and operating in the different mode of operation by: driving the left loudspeaker using the left audio signals, the right audio signals, the center audio signals, the left elevation audio signals, and the right elevation audio signals; driving the right loudspeaker using the left audio signals, the right audio signals, the center audio signals, the left elevation audio signals, and the right elevation audio signals; and driving the center loudspeaker using the left audio signals, the right audio signals, the center audio signals, the left elevation audio signals, and the right elevation audio signals. The method can include receiving a user command via a user interface, and transitioning to the different mode of operation in response to the user command. The left loudspeaker, the right loudspeaker, and the center loudspeaker can be enclosed inside a shared enclosure.

Various aspect of the disclosure can relate to a loudspeaker system, which can include a left speaker; a right speaker; a center speaker positioned between the left speaker and the right speaker; and a signal processor, which can be configured to: receive a left audio signal; receive a right audio signal; receive a left elevation audio signal; receive a right elevation audio signal; drive the left speaker based at least in part on the left audio signal and the left elevation audio signal; drive the right speaker based at least in part on the right audio signal and the right elevation audio signal; and drive the center speaker based at least in part on the left elevation audio signal and the right elevation audio signal.

The signal processor can be configured to receiving a center audio signal and to drive the center speaker based at least in part on the center audio signal. The signal processor can be a digital signal processor. The signal processor can be a signal renderer. The signal processor can be configured to drive the center speaker based at least in part on an inverted signal that is based on the left elevation audio signal and the right elevation audio signal. The signal processor can be configured to combine the left elevation audio signal and the right elevation audio signal into a combined elevation signal; invert the combined elevation signal to produce an inverted combined elevation signal; and drive the center speaker based at least in part on the inverted combined elevation signal. The signal processor can be configured to drive the left speaker based at least in part on an inverted instance of the left elevation audio signal, and to drive the right speaker based at least in part on an inverted instance of the right elevation audio signal. The signal processor can be configured to: generate an inverted left elevation audio signal; generate an inverted right elevation audio signal; drive the left speaker based at least in part on the inverted left elevation audio signal; and drive the right speaker based at least in part on the inverted right elevation audio signal. The loudspeaker system can be configured to use the sounds produced by the left speaker based on the left elevation audio signal and the sounds produced by the right speaker based on the right elevation audio signal to at least partially cancel sounds produced by the center speaker based on the left elevation audio signal and the right elevation audio signal at a null. The signal processor can be configured to apply a first delay to signals that are provided to the center speaker based on the left elevation audio signal and the right elevation audio signal. The signal processor can be configured to apply a second delay to signals that are provided to the left speaker based on the left elevation audio signal, and to apply the second delay to signals that are provided to the right speaker based on the right elevation audio signal. The signal processor can be configured to adjust a relative delay between the first delay and the second delay to move the null. The loudspeaker system can be configured to receive user input and to adjust the relative delay to move the null based on the user input. The loudspeaker system can be configured to automatically move the null towards a listening position. The loudspeaker system can be configured to transition to a different operating mode in which the signal processor is configured to: drive the left speaker using the left audio signal, the right audio signal, the center audio signal, the left elevation audio signal, and the right elevation audio signal; drive the right speaker using the left audio signal, the right audio signal, the center audio signal, the left elevation audio signal, and the right elevation audio signal; and drive the center speaker using the left audio signal, the right audio signal, the center audio signal, the left elevation audio signal, and the right elevation audio signal. The loudspeaker system can be configured to receive user input and to transition to the different operating mode in response to the user input.

Various aspect of the disclosure can relate to a method, which can include receiving a left audio signal; receiving a right audio signal; receiving a left elevation audio signal; receiving a right elevation audio signal; generating a combined height audio signal based at least on the left elevation audio signal and the right elevation audio signal; driving the center loudspeaker based at least in part on the combined height audio signal; generating a left elevation cancelation audio signal based at least on the left elevation audio signal and a right elevation cancelation audio signal based at least on the right elevation audio signal; driving a left loudspeaker based at least in part on the left audio signal and the left elevation cancelation audio signal; and driving a right loudspeaker based at least in part on the right audio signal and the right elevation cancelation audio signal.

The method can include receiving a center audio signal, and driving the center loudspeaker driver based at least in part on the center audio signal. The combined height audio signal can be an inverted signal that is based on the left elevation audio signal and the right elevation audio signal. The method can include combining the left elevation audio signal and the right elevation audio signal into a combined signal; and invert the combined signal to produce the combined height audio signal. The left elevation cancelation audio signal used to drive the left speaker can be based at least in part on an inverted instance of the left elevation audio signal. The method can include generating an inverted left elevation audio signal; generating an inverted right elevation audio signal; drive the left speaker based at least in part on the inverted left elevation audio signal; and drive the right speaker based at least in part on the inverted right elevation audio signal. In some embodiments, sounds produced by the left elevation cancelation audio signal and the right elevation cancelation audio signal at least partially cancel sounds produced by the combined height audio signal to form a null. The method can include applying a first delay to signals that are provided to the center speaker based on the left elevation audio signal and the right elevation audio signal. The method can include applying a second delay to signals that are provided to the left speaker based on the left elevation audio signal, and to apply the second delay to signals that are provided to the right speaker based on the right elevation audio signal. The method can include adjusting a relative delay between the first delay and the second delay to move the null. The loudspeaker system can be configured to receive user input and to adjust the relative delay to move the null based on the user input. The loudspeaker system can be configured to automatically move the null towards a listening position. The method can include positioning a microphone at the listening position and adjusting the relative delay based at least in part on sounds measured by the microphone at the listening position.

Various aspect of the disclosure can relate to a computer-readable medium (e.g. a non-transitory computer readable medium) that includes instructions that can be read by a computer processor to cause the computer processor to: receive a left audio signal; receive a right audio signal; receive a left elevation audio signal; receive a right elevation audio signal; generate a combined height audio signal based at least on the left elevation audio signal and the right elevation audio signal; generate a left elevation cancelation audio signal based at least on the left elevation audio signal and a right elevation cancelation audio signal based at least on the right elevation audio signal; drive a center loudspeaker based at least in part on the combined height audio signal; drive a left loudspeaker based at least in part on the left audio signal and the left elevation cancelation audio signal; and drive a right loudspeaker based at least in part on the right audio signal and the right elevation cancelation audio signal.

The instructions can be configured to cause the computer processor to receive a center audio signal, and drive the center loudspeaker driver based at least in part on the center audio signal. The instructions can be configured to cause the computer processor to preform the other functions discussed herein.

Various aspect of the disclosure can relate to a loudspeaker system, which can include a left speaker; a right speaker; a left elevation speaker aiming generally upward; a right elevation speaker aiming generally upward; a signal processor, which can be configured to: receive a left audio signal; receive a right audio signal; receive a left elevation audio signal; receive a right elevation audio signal; invert the left elevation audio signal to produce an inverted left elevation audio signal; invert the right elevation audio signal to produce an inverted right elevation audio signal; drive the left elevation speaker based at least in part on the inverted left elevation audio signal; drive the right elevation speaker based at least in part on the inverted right elevation audio signal; drive the left speaker based at least in part on the left audio signal and the left elevation audio signal; and drive the right speaker based at least in part on the right audio signal and the right elevation audio signal.

The signal processor can be configured to receiving a center audio signal and to drive a center speaker based at least in part on the center audio signal.

The above and still further objects, features, and advantages of aspects of the present disclosure will become apparent upon consideration of the following detailed description of example embodiments, particularly when taken in conjunction with the accompanying drawings, wherein like reference numerals in the various figures are utilized to designate like components.

### BRIEF DESCRIPTION OF THE DRAWINGS

Certain embodiments will be discussed with reference to the following figures, wherein like reference numerals can generally refer to similar features throughout. The figures are provided for illustrative purposes and the innovations are not limited to the specific implementations illustrated in the figures. The drawings referenced herein form a part of the specification and are incorporated herein by reference. Features shown in the drawings are meant as illustrative of one or more embodiments, and not necessarily of all embodiments, unless otherwise explicitly indicated.

FIGS. 1A and 1B illustrate a multichannel (e.g., Dolby Digital™ 7.1) Home Theater audio reproduction or playback system with no elevation or height channel speakers, in a room having a defined listening position.

FIGS. 1C, 1D, and 1E illustrate soundbar style audio systems, such as home theater audio reproduction or playback systems.

FIG. 1F illustrates the use of an upward-firing height channel signal projecting driver using reflected sound to simulate an overhead speaker for generating an overhead apparent sound source as part of an immersive listening environment.

FIG. 1G is an illustration of an example Denon Home™ All-in-One single enclosure wireless stereo-system or smart speaker.

FIG. 2 is a three loudspeaker driver development prototype of the audio playback system configured with an upwardly aimed center/height (C/H) channel speaker positioned between a stereo pair (e.g., left and right) speakers to create both height channel playback and center channel playback without requiring separate left height and right height amplifiers or speakers.

FIG. 3 is an annotated diagram illustrating a side view of a center/height speaker and a left speaker (e.g., C/H and L elements of the L-C/H-R array of FIG. 2) illustrating an example signal processing method for creating a null at the listening location and aiming that null by adjusting delays to create a user-perceived height (H) content apparent sound source which appears to emanate from the ceiling while preserving user-perceived center (C) content from the center/height speaker, thereby emphasizing Le/Re/H sound reflected toward the listener from the ceiling.

FIG. 4 is an annotated diagram illustrating a side view of the center/height speaker and left speaker (C/H and L elements of the L-C/H-R array of FIG. 2) illustrating an example signal processing method for aiming the null at the ceiling for a reflection to the listening location to emphasize the user-perceived height (H) content apparent sound source emanating from the ceiling while generating no null for center (C) content from the center/height speaker.

FIG. 5 is a signal flow diagram illustrating an example signal processing method for receiving a plurality (e.g., seven) incoming (e.g., ATMOS™) signals, namely Front Left (L), Front Right (R), Center (C), Left Back (Lb), Right Back (Rb), Left Elevation (Le) and Right Elevation (Re) signals, and then rendering those incoming signals into a left element signal, a center/height element signal, and a right element signal, with selected signal modifications and delays applied to the incoming signals to provide an enhanced sweet spot listening experience. This figure is a flow diagram from a DSP Concepts'AWE™ screenshot illustrating an example embodiment for creating a strong null for H that can be especially useful for a first user-selectable mode optimized for sweet spot listening.

FIG. 6 is another signal flow diagram illustrating an example signal processing method for receiving the same seven incoming signals, namely Front Left (L), Front Right (R), Center (C), Left Back (Lb), Right Back (Rb), Left Elevation (Le), and Right Elevation (Re) signals, and then rendering those incoming signals into a left element signal, a center/height element signal and a right element signal, with selected signal modifications and delays applied to the incoming signals to provide a different user-selectable experience. This figure is also a flow diagram from a DSP Concepts' AWE™ screenshot illustrating an example embodiment for creating a larger listening area with more even coverage that is better suited to entertaining many listeners, thereby providing a “party mode” user-selectable listening option.

FIG. 7 illustrates the actual radiation pattern of the three element speaker array of Figure illustrating the orientation of the axes of the null vectors, as visualized from the listening position in front of the three element array.

FIG. 8 comprises a diagram illustrating the relative positions and orientations used to determine the path lengths or distances used to calculate and then generate delays desired to achieve the user selectable sonic effects disclosed herein. The diagram's side view of the listening space shows the system projecting sound up to the ceiling for reflection down to a listening position with a seated listener or user's ears at a selected height, using the equations on the right, reflected path length differences and delay variations can be calculated to achieve user selectable sonic effects.

FIG. 9A comprises a diagram and spreadsheet entries which (along with the equations of FIG. 8) illustrate the relative positions and orientations for a user whose ears are at a height of about 47 inches and for a system height of about 56 inches above the floor (e.g., as may be recommended for a large version of the system and a listening distance of about 12 feet). These inputs are to calculate short delay variations of path lengths or distances to achieve the user selectable sonic effects.

FIG. 9B comprises a diagram and spreadsheet entries which (along with the equations of FIG. 8) illustrate the relative positions and orientations for a user whose ears are at a reclined height of about 33 inches and for a system height of about 42 inches above the floor, which can result in short delay variations to achieve the user selectable sonic effects.

FIG. 9C comprises a diagram and spreadsheet entries which (along with the equations of FIG. 8) illustrate the relative positions and orientations that can be used to input and calculate variations of path lengths or distances to achieve user selected two Channel (“stereo”) sonic effects.

FIG. 10 shows an example embodiment of a speaker system with multiple drivers.

FIG. 11 shows another example embodiment of a speaker system with multiple drivers.

FIG. 12 shows an flowchart of an example embodiment of a method for automated positioning of the null.

### DETAILED DESCRIPTION OF CERTAIN EMBODIMENTS

The various features and advantages of the systems, devices, and methods of the technology described herein will become more fully apparent from the following description of the examples illustrated in the figures. These examples are intended to illustrate the principles of this disclosure, and this disclosure should not be limited to merely the illustrated examples. The features of the illustrated examples can be modified, combined, removed, and/or substituted as will be apparent to those of ordinary skill in the art upon consideration of the principles disclosed herein.

It will be readily understood that the components and features of the example embodiments, as generally described herein and illustrated in the Figures, may be arranged and designed in a wide variety of different configurations. Thus, the following detailed description of the embodiments of the methods, devices, assemblies, apparatus, systems, products, modules, submodules, etc., is not intended to limit the scope of the embodiments, but is merely representative of selected embodiments.

Reference throughout this specification to “a select embodiment,” “one embodiment,” “an exemplary embodiment,” “exemplary embodiments,” “an embodiment,” “embodiments,” “example embodiments,” or the like means that a particular feature, structure, or characteristic described in connection with the embodiment(s) is included in at least one embodiment. Thus, appearances of the phrases “in a select embodiment,” “in one embodiment,” “in an exemplary embodiment,” “in exemplary embodiments,” “in an embodiment,” “in embodiments,” “in example embodiments,” or the like in various places throughout this specification are not necessarily referring to the same embodiment(s) or only a single embodiment. The embodiments may be, for example, combined with one another in various combinations and modified to include features of one another.

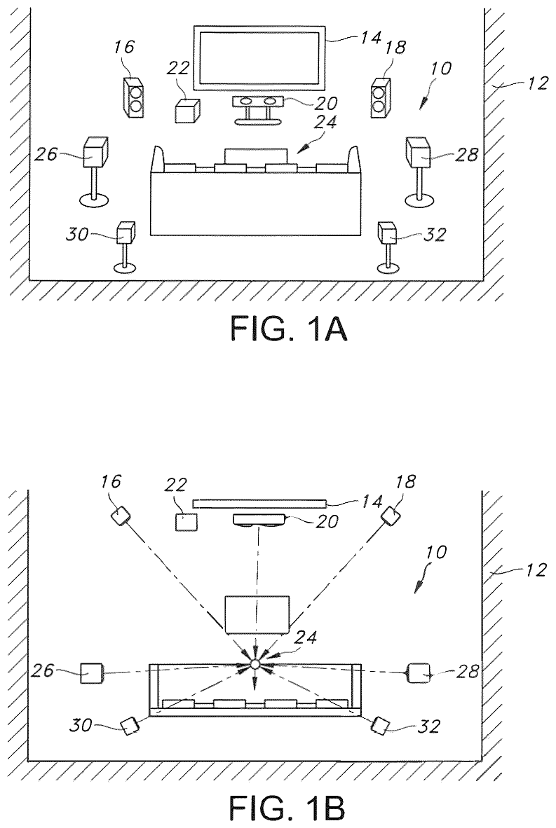

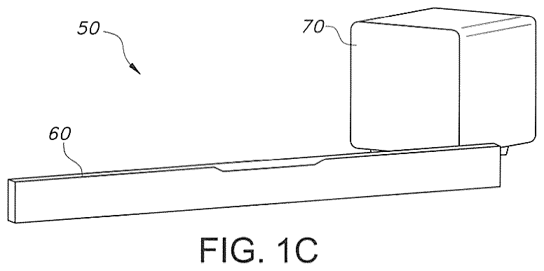

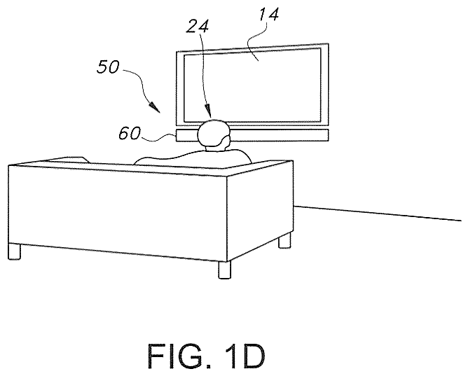

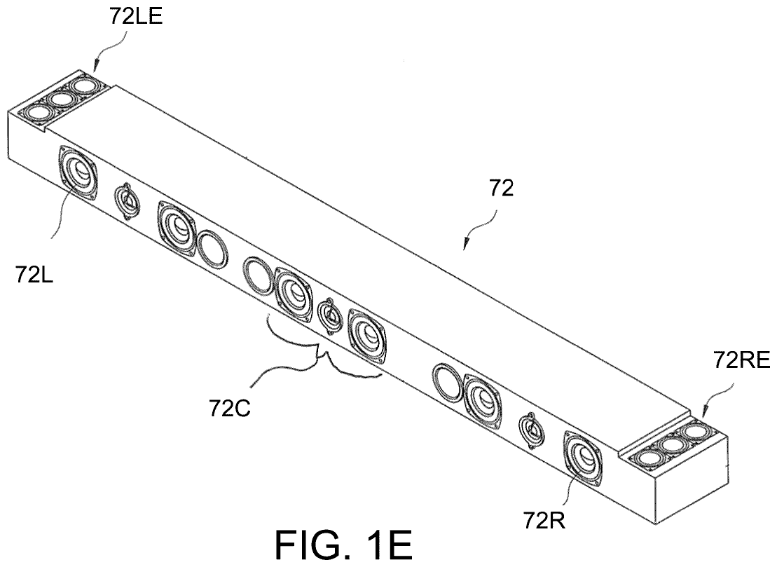

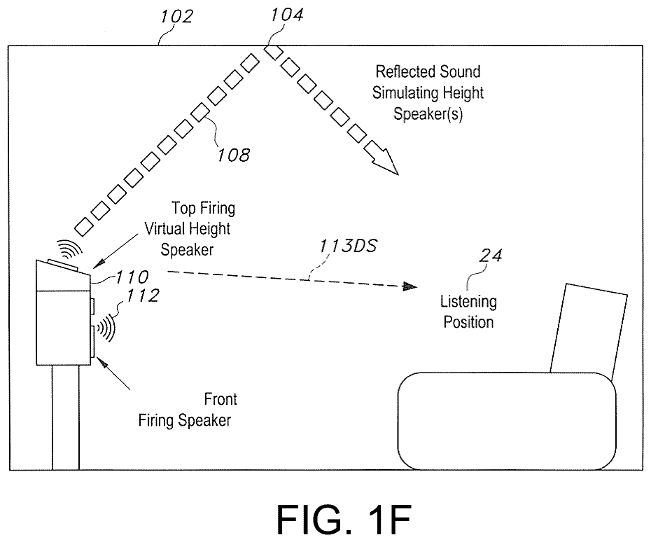

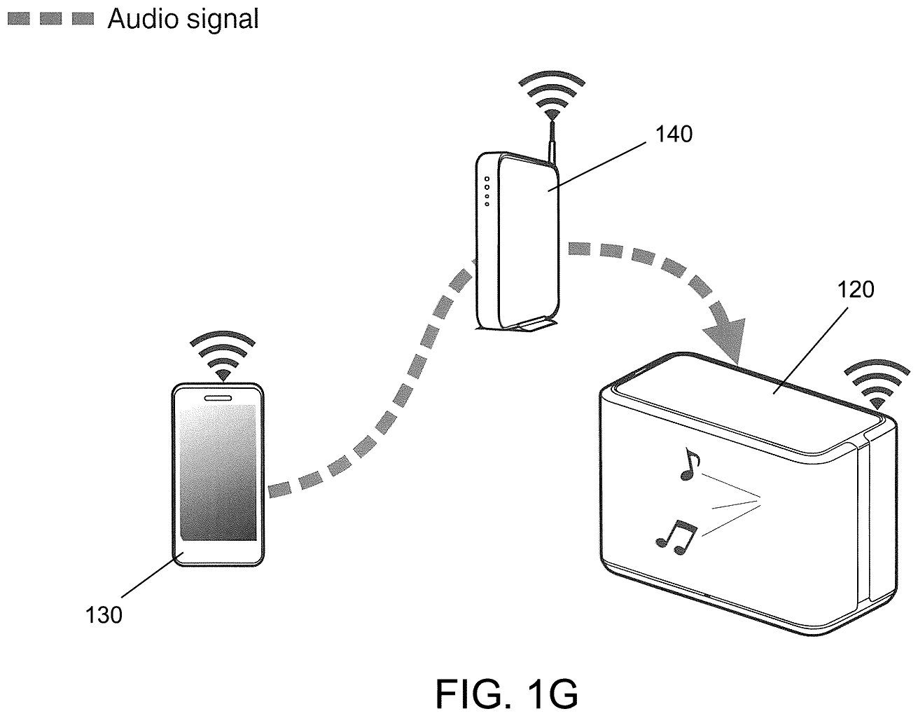

Listeners can use “stereo” or “home theater” audio systems for music playback and other types of audio reproduction. Surround-sound or home theater loudspeakers can be configured for use with standardized home theater audio systems having a plurality of playback channels, each channel typically served by an amplifier and a loudspeaker. In some Dolby™ home theater audio playback systems, for example, there can be five or more channels of substantially full range material plus a subwoofer channel configured to reproduce band-limited low frequency material. The substantially full range channels and speaker locations in some Dolby Digital™ systems can be (a) center 20, (b) left front 16, (c) right front 18, (d) left and right side 26, 28 and (e) left and right surround speakers 30, 32 (e.g., as shown in FIGS. 1A and 1B), although other configurations are possible. The left front and right front channel loudspeakers 16, 18 can be positioned in a home theater system near the left and right sides of a video monitor or television 14, and the left front and right front channels can be used by content creators for “stereo” (e.g., music) signals and sound effects. Home theater system users or listeners in a listening space with a multi-channel system (e.g., 10 as shown in FIGS. 1A and 1B) can be surrounded with multiple pairs of loudspeakers (e.g., a left and right front speakers 16, 18, and two pairs of surround channel loudspeakers placed laterally 26, 28 and behind 30, 32 the seating area 24). So home theater setups can place the listener in a room 12 at a listening position 24 in front of a screen or display 14 with the loudspeakers all aimed at the listening position 12. But many users want more flexibility and fewer speaker enclosures to set up in their room.

Unfortunately, when typical multi-component home theater systems are installed in listener's homes, setup problems are encountered and many users struggle with speaker placement, component connections and related complications. In response, many listeners resort to the convenience of “soundbar” style home theater loudspeaker systems (e.g., 50 or 72) which can incorporate at least left front, center, and right front channels into a single soundbar enclosure (e.g., 60), which can be configured for use near the user's video display (as shown in FIGS. 1C, 1D and 1E), and a separate subwoofer (e.g., 70) in some cases. For example Polk Audio and Denon companies have developed a number of multi-channel soundbar systems including those described and illustrated in (a) U.S. Pat. No. 11,937,066, (b) U.S. Pat. No. 9,374,640, (c) U.S. Pat. No. 9,185,490, and (d) U.S. Pat. No. 7,231,053, the entire disclosures of which are also incorporated herein by reference.

Modern commercial Cinemas can be equipped with sound systems designed to create an “immersive” or “3-D” sound field with loudspeakers that create sounds which come from sources that are above or overhead. For example, the Dolby® Atmos™ spatial audio system places loudspeakers in or on the theater's ceiling to provide overhead sound sources, and reproduction of Dolby® Atmos™ “height” or elevation program material is now possible using loudspeakers in the home, as described in U.S. Pat. No. 9,648,440, the entire disclosure of which is incorporated by reference. A consumer or home theater enthusiast who wants to recreate the immersive 3-D sound field experienced with the Dolby® Atmos™ system can configure and install a system with “Virtual Height” speakers such as those described and illustrated in U.S. Pat. No. 9,648,440. Competing Height-Channel or vertically immersive elevation audio reproduction speaker systems are sold by DTS, Inc. (in connection with the “DTS-X®“brand name) and Sony (in connection with the 360 Reality Audio brand name). Spatial or 3-D Immersive audio systems (like Atmos) don't necessarily organize incoming audio signals into “channels” as described above. Instead, most sounds are treated as “objects.” Instead of assigning a sound to a channel (and by extension, a speaker), Atmos lets audio producers and filmmakers assign a sound to a place. Not “left front speaker” but “left front corner.” Not “pan from left front speaker through center speaker to right front speaker” but “pan smoothly across the front wall.” These spatial or 3-D Immersive audio system objects can then be rendered or used to generate Left, Center and Right (LCR) channel-specific signals by a signal processor.

Height-Channel speakers or speakers with upward firing elevation modules such as those illustrated in FIG. 1F, can achieve a simulated height speaker effect or phantom sonic image from a ceiling location 104 but each requires a dedicated physical top-firing driver or transducer 110 which adds cost (e.g., for at least left and right top-firing drivers on left front and right front speakers 112). Those top-firing drivers 110 are also not entirely satisfactory in actual use, because top-firing Height-Channel speakers do not radiate sound 108 (for the overhead sound image) solely toward the ceiling 102 (at 104, in FIG. 1F), and thus create audibly flawed reproduced sound at the listening position (e.g., 24 in FIGS. 1A, 1B, 1D and 1F). Audible sonic flaws can arise from the listener's perception of undesirable directly radiated sound 113DS from Height-Channel 110 which follows a substantially horizontal line directly from Height-Channel speaker 110 toward listening position 24 (as shown in FIG. 1F). A multi transducer soundbar system 72 can have a unitary housing supporting and aiming a left front speaker module 72L, a Center channel speaker module 72C and a right front speaker module 72R and left and right side upward firing elevation modules 72LE and 72RE, as seen in FIG. 1E.

“All-in-one” home audio systems (e.g. 120) can be more compact than soundbar systems (e.g., 50) and may be configured as single enclosure multi-driver loudspeaker system or wireless smart speaker (e.g., 120 of FIG. 1G). A smart speaker 120 can include signal processing circuitry for receiving audio signals via BlueTooth™ wireless transmission (e.g., from a streaming app on smartphone 130) or WiFi signals (e.g., from router 140 or via wired network or analog input connections). Smart speakers (e.g., 120) can be configured in a single enclosure with multiple channels of amplification powering multiple transducers or drivers to project a stereo soundstage in a listener's room (e.g., 10) and can be oriented toward a listening position (e.g., 24). However, in some cases, smart speakers do not accommodate users who want to experience a user-selectable home theater or stereo listening experience with or without elevation/height (e.g., ATMOS™, DTS-X™, or 360 Reality™) vertical sound envelopment capabilities.

Some embodiments disclosed herein relate to an economical and easy-to-use loudspeaker system and signal processing method for reproducing a wider variety of audio program material with satisfying sound for (a) individual listeners and (b) groups of listeners in a room having a variety of standing or seating spaces, where each listener may desire spacious sound (e.g., for a party) for music playback with or without height channel reproduction, selectable for either a “party” mode or a single listener “sweet spot” mode (e.g., for a listener seated in a “sweet spot” listening position 24).

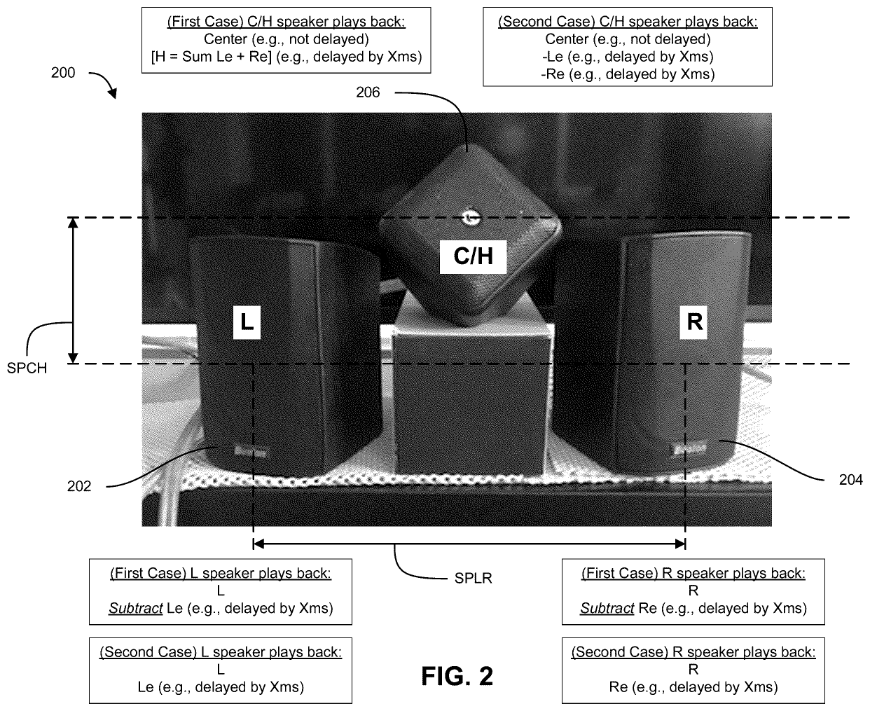

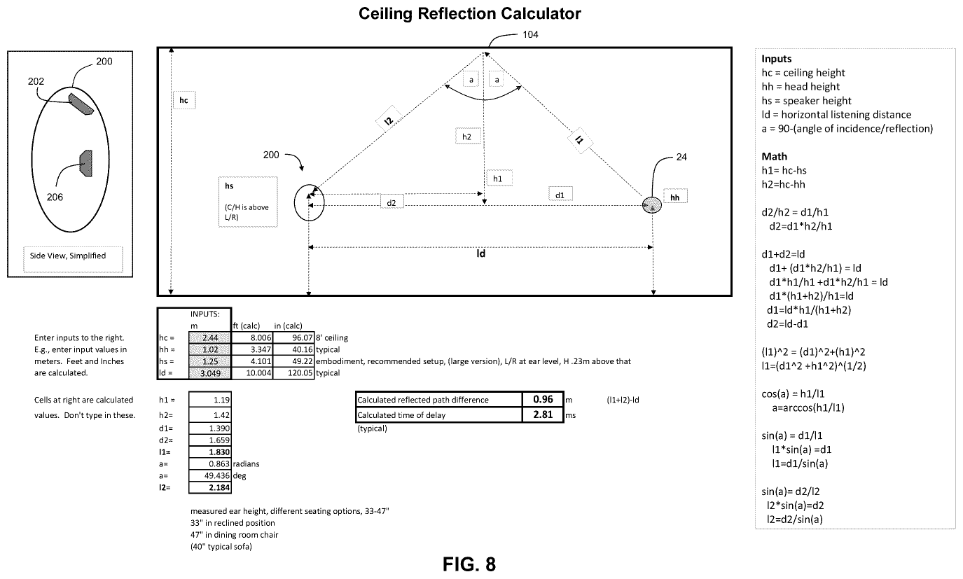

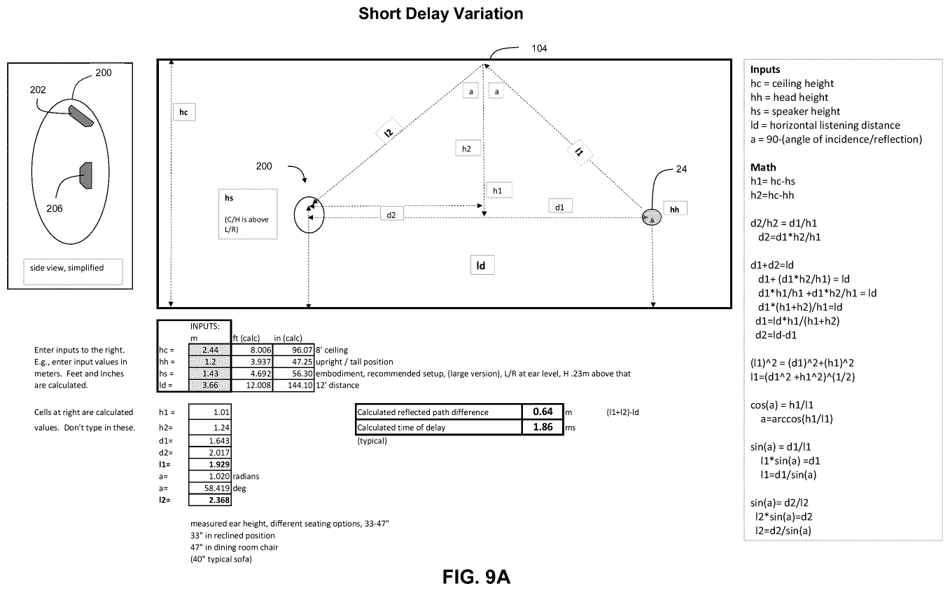

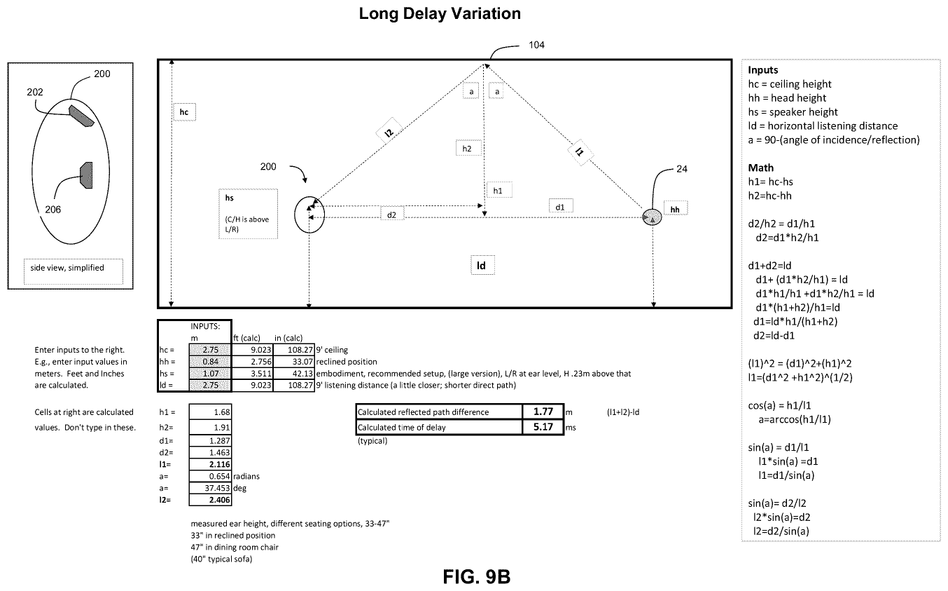

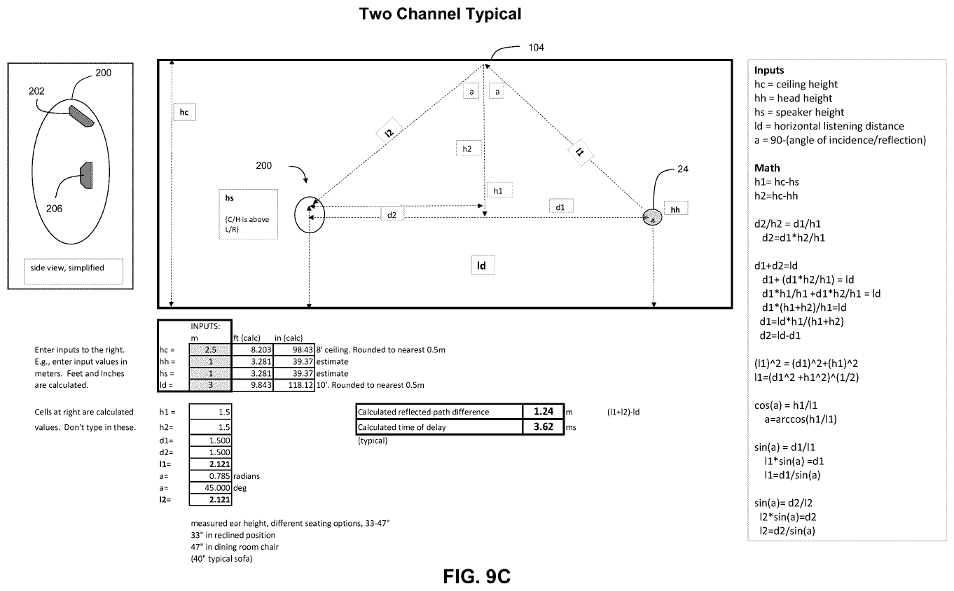

One or more example embodiments described herein seek to mitigate the above-mentioned difficulties and provide an improved loudspeaker system. In an example embodiment illustrated in FIGS. 2-4, 7, and 8-9C, the left and right speakers (202, 204) can be aimed forwardly in a substantially horizontal listening plane (e.g., at about ear level), and can be aimed at the listening position 24, for example. The left and right speakers (202, 204) and can be spaced apart by a selected L-R spacing distance SPL-R (e.g., of 6-18 inches). The selected L-R spacing distance can be about 6 inches, about 8 inches, about 10 inches, about 12 inches, about 14 inches, about 16 inches, about 18 inches, about 20 inches, about 24 inches, or more, or any values or ranges between any of these values, although other configurations are possible. The center/height speaker 206 can be positioned between the left and right speakers 202, 204, and can be positioned slightly above the left and right speakers by a distance SPCH (e.g., 3-15 inches above the L and R speakers). The distance SPCH can be about 3 inches, about 4 inches, about 5 inches, about 6 inches, about 8 inches, about 10 inches, about 12 inches, about 15 inches, about 18 inches, or more, or any values or ranges between any of these values, although other configurations are possible. The center/height speaker 206 can be aimed upwardly, such as at a selected acute C/H aiming angle (e.g., 20 to 60 degrees) with respect to that horizontal listening plane, toward the ceiling at a ceiling reflection point selected for a phantom sonic image from a ceiling location 104. The center/height speaker 206 can be configured to aim generally upward and/or forward, and can be angled upward from the horizontal plane by the C/H aiming angle that can be about 10 degrees, about 15 degrees, about 20 degrees, about 25 degrees, about 30 degrees, about 40 degrees, about 45 degrees, about 50 degrees, about 55 degrees, about 60 degrees, about 65 degrees, about 70 degrees, about 75 degrees, or more, or any values or ranges between any of these values, although other configurations are possible. For an all-in-one single enclosure embodiment which may superficially resemble smart speaker 120, the preferred L-R spacing (SPL-R) can be approximately 8 inches. Referring to FIGS. 8-9C, the upward aiming angle of C/H speaker 206 creates a selected incidence angle “a” at the ceiling reflection point 104.

The image of FIG. 2 illustrates an early development prototype in which left speaker 202 has its acoustic center substantially within the substantially horizontal listening plane (at about ear level) aimed at the listening position 24. The left speaker 202 may optionally be toed in in some embodiment (e.g., to aim more directly at listening position 24) or toed out, as shown in FIG. 2. In a mirror image orientation, right speaker 204 has its acoustic center substantially within the horizontal listening plane (e.g., at about ear level) aimed at the listening position 24. The right speaker 204 may optionally be toed in (e.g., to aim more directly at listening position 24) or toed out, as shown. The selected L-R spacing distance SPLR is defined between the acoustic centers of left speaker 202 and right speaker 204 (e.g., 6-18 inches). The center/height speaker 206 can be positioned between the right speaker 204 and the left speaker 202, such as in a substantially centered position between them. The center/height speaker 202 can be positioned slightly above the L and R speakers by a vertical spacing SPCH which can be defined between acoustic center of the C/H speaker 206 and the horizontal listening plane and/or the acoustic center of the left speaker 202 and/or the right speaker 204 (e.g., 3-15 inches above the L and R speakers). The center/height speaker 206 can be aimed upwardly at a selected acute C/H aiming angle (e.g., 20 to 60 degrees), such as with respect to that horizontal listening plane.

In one or more example embodiments, selective cancellation of signals at a listening position LP (e.g., location 24) (which can be referred to as “the sweet spot”), such as by digital signal processing, increases the impression of width/height, especially when combined with strategically aiming the speakers to engage a listening environment, (e.g., room 12). For certain types of listening, such as casual or social listening, a more balanced sound field can be advantageous, given that listeners do not necessarily want to be blasted with height effects directly aimed at them. Further, many listeners may want to be able to position themselves in a room “off-axis” at a location other than (e.g., to the right or left of) the sweet spot, including casually walking about different parts of the room, without sacrificing the listeners'listening experience. Furthermore, casual listeners may want to experience audio (e.g., vocals) well without being drowned out by height effects. Accordingly, some embodiments can include an audio system that has multiple operating modes. For example, in a first operating mode, the audio system can be configured to optimize a specific listening position 24, which can provide a listening sweet spot. As discussed herein, the audio system can be configured to position a null at the listening position 24, such as by using destructive interference to cancel out certain sounds at the listening position 24 while emphasizing other sounds, as discussed herein. In a second operating mode, the audio system can play the audio more evenly throughout the listening environment, such as without optimizing the specific listening position 24. The second operating mode can be more appropriate when the multiple listeners are distributed throughout the listening environment, or when the listener(s) are moving around within the listening environment.

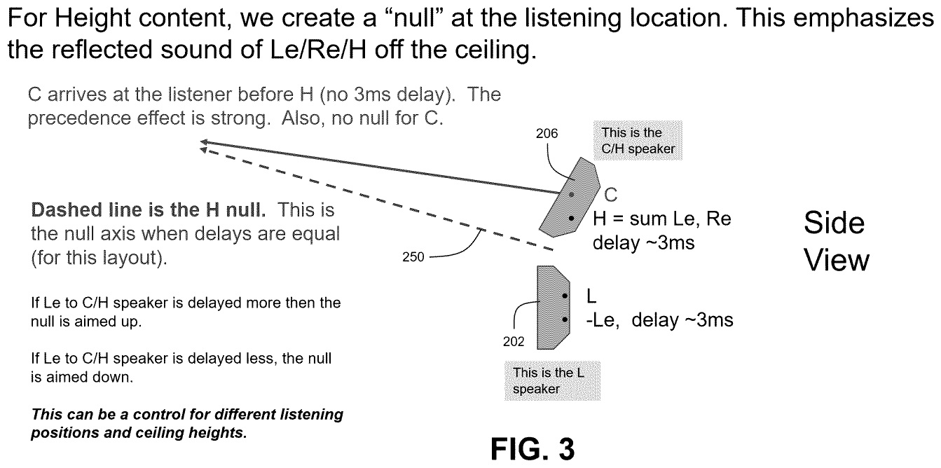

Referring initially to FIGS. 2-9C, in an example embodiment, system 200 can receive a left front channel signal (“L”), a left elevation or height channel signal (“Le”), a center channel signal (“C”), a right front channel signal (“R”), and a right elevation or height channel signal (“Re”). The signals can be received in, for example, an ATMOS™ signal transmission. In this example embodiment (e.g., see FIGS. 3-6), the Left speaker element 202 reproduces a signal comprising L−(Le, which can be delayed by Xms), while the Right speaker element 204 reproduces a signal comprising R−(Re, which can be delayed by Xms). The Center/Height speaker element 206 can reproduce a signal comprising two portions, namely C (not delayed) plus a height signal defined as H=(sum Le+Re, which can be delayed by Xms). This configuration and signal processing method can generate convincing apparent height or elevation sound images above the listener, whereby height channel signals are played back through the L-C/H-R array shown in FIGS. 2-4 and 7, without the need to add dedicated elevation or height (H) channel speakers. System 200 does so by forming a “null” in vicinity of the listener (e.g., at the listening position (LP) 24) where the direct H content is cancelled, greatly accentuating the sound which seems to come from above (e.g., from the ceiling). The null is formed by acoustically superimposing projected sounds along a null axis 250, which can be aimed by creating selected delays, as discussed herein. By adjusting the timing of the signals projected from speaker array elements 202, 204, 206 (e.g., the Xms delays), the system can allow for user control over the aimed angle of the null vector 250, such as in order to get the best effect for their listening setup. Another way of expressing the signal flows for the embodiment of FIG. 2 is:
Left Speaker 202 plays back [L+(Le′, which can be delayed by Xms)];
Right Speaker 204 plays back [R+(Re′, which can be delayed by Xms)]; and
Center/Height Speaker 206 plays back [C+(Le+Re, which can be delayed by Xms)];

### Where Le′=−Le, Re′=−Re.

There are options for how the signals are processed and combined (e.g., which signals are phase inverted with respect to the other signals). In simple terms, a null can be formed by sending Le, Re signals to one speaker or speakers in conjunction with phase inverted Le, Re signals (e.g., −Le and −Re) to another speaker or speakers. The example described above and shown in FIG. 2 illustrates one implementation, (“the first case”) where the left speaker 202 plays back [L−Le], the right speaker 204 plays back [R−Re], and the center/height speaker 206 plays back [C+(Le+Re)]. In alternative embodiments, (“the second case”) for which promising prototypes appear to provide a better result in some cases, the method includes sending [L+Le] to the left speaker 202, sending [R+Re] to the right speaker, and sending [C+(−Le−Re)] to the center/height speaker 206. Both first and second case embodiments provide surprisingly effective results, but the second case embodiment may be a preferred embodiment, in some cases. One way to address both cases is to use Le′ and Le″ to denote oppositely phased versions of the same signal, without requiring either one to be per the original phase (e.g., Le′=−Le″, Re′=−Re″). Using that nomenclature the signals can be sent to the speakers as follows:
Left Speaker 202 plays back [L+(Le′, which can be delayed by Xms)];
Right Speaker 204 plays back [R+(Re′, which can be delayed by Xms)]; and
Center/Height Speaker 206 plays back [C+(Le″ Re″, which can be delayed by Xms)].

The “first case” and the “second case” signals are annotated in FIG. 2. In some situations, the “first case” can cause the sound from the −Le signals emitted by the left speaker 202 to cancel or attenuate some of the sound from the L signals emitted by the left speaker 202, such as when the audio content has similar sounds for the L and Le signals. Similarly, the sound from the −Re signals emitted by the right speaker 204 can cancel or attenuate some of the sound from R signal emitted by the right speaker 204, such as when the audio content has similar sounds for the R and Re signals. Accordingly, in some situations, the “first case” approach can result in the sounds from the L and R signals being attenuated and more difficult to hear at the listening location 24.

The “second case” approach can resolve this issue by using the L signals and the uninverted Le signals to drive the left speaker 202, and by using the R signals and the uninverted Re signals to the drive the right speaker 204. The L and Le signals tend to complement each other (rather than cancel each other), and the R and Re signals tent to complement each other (rather than cancel each other). In the “second case” approach, the-Le and-Re signals are used to drive the center/height driver 206 (e.g., along with the C signals). The sound generated by the −Le and −Re signals can bounce off the ceiling and approach the listening location from above, so that the listener perceives those sounds as coming from above. Some of the sound generated by the −Le and −Re signals is also sent directly from the speaker 206 to the listening location (e.g., sometimes referred to as direct height sound), and that sound can be undesired because it would be perceived as coming from straight ahead, rather than from above, and those signals are for height/elevation. The sounds generated by the left speaker 202 playing the Le signals and the right speaker 204 playing the Re signals can cancel or attenuate the direct height sounds from the center speaker 206 playing the −Re and −Le signals, which can create a null, as discussed herein. The null can be positioned at the listening position, and in some cases, the system can be configured to move the null, as discussed herein. When the listener is at the null location, the listener would not hear the direct height sound (e.g., from the −Re and −Le signals) that travels directly from the center/height speaker 206 to the listening location, because the direct height sound is cancelled at the null. The listener would hear the height sound (e.g., from the −Re and −Le signals) that bounces off the ceiling and approaches the listener from above. Using the −Re and −Le signals or the Re and Le signals for height/elevation can produce similar sounds that bounce off the ceiling to provide the height or elevation effect, but using the-Re and-Le signals (the “second case”) can provide the benefit that the direct sound from the-Re and-Le signals that does not bounce off the ceiling can be cancelled without attenuating the L and R sounds, in some situations.

The null does not cancel or attenuate all the sound at the null location (e.g., at the listening location 24). The null can cancel or attenuate the undesired direct height sound (e.g., from the −Le and −Re signals that travels directly from the center speaker 206 to the listening location 24 without bouncing off the ceiling). But the null does not cancel the sounds from the −Le and −Re signals that do bounce off the ceiling. Also, the null does not cancel the sounds from the C signals played by the center/height speaker 206 (e.g., which travel directly to the listening location 24). Some of the sound produced by the C signals is directed upward and bounces off the ceiling, and then approaches the listening location from above. However, because the direct C sound arrives at the listening location 24 slightly before the C sound that bounces off the ceiling (e.g., due to the shorter path length), the listener at the listening location 24 can perceive the C sound as coming from the direct or forward direction rather than from above. The precedence effect is a psychoacoustic phenomenon in which two similar sounds that arrive at a listener within a short amount of time and the listener perceives the origin of the sound based predominantly on the location of the sound that arrived first. Stated another way, the human mind tends to perceive the location of a sound based on the first instance of hearing that sound rather than based on the echoes or reverberations of the sound. According, even though the listener hears the sound from the C signals that bounce off the ceiling, the listener tends to perceive the sounds as originating from the center speaker 206, rather than from the ceiling, because the direct sound from the center speaker 206 reaches the listening location first.

The “second case” approach of using the-Re and-Le signals for the height or elevation sounds so that the direct height sound can be canceled using the Re and Le signals without canceling the sound from the R and L signals, can be applied to speaker systems that do not use a combined center/height speaker 206. For example, an audio system can include a right speaker, a left speaker, a right elevation speaker (e.g., aimed generally upward), and left elevation speaker (e.g., aimed generally upward). The right elevation speaker can play sounds based on the −Re signals, and the left elevation speaker can play sounds based on the −Le signals. The right speaker can play sounds based on the Re signals (e.g., for canceling the right direct height sound) and also based on the R signals. The left speaker can play sounds based on the Le signals (e.g., for canceling the left direct height sound) and also based on the L signals. This approach can be applied to the audio systems disclosed in U.S. Pat. No. 11,937,066 and U.S. Patent Application Publication No. 2021/0409866, which are both incorporated herein by reference. The audio system can be similar to the speaker system 72 of FIG. 1E, in some cases. The audio system can include other features similar to those discussed herein, which are not repeated here.

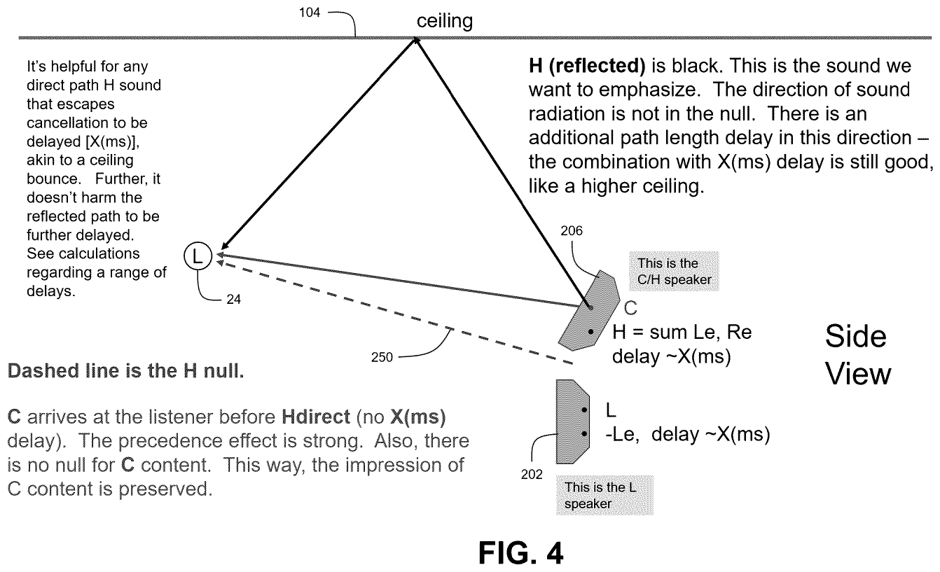

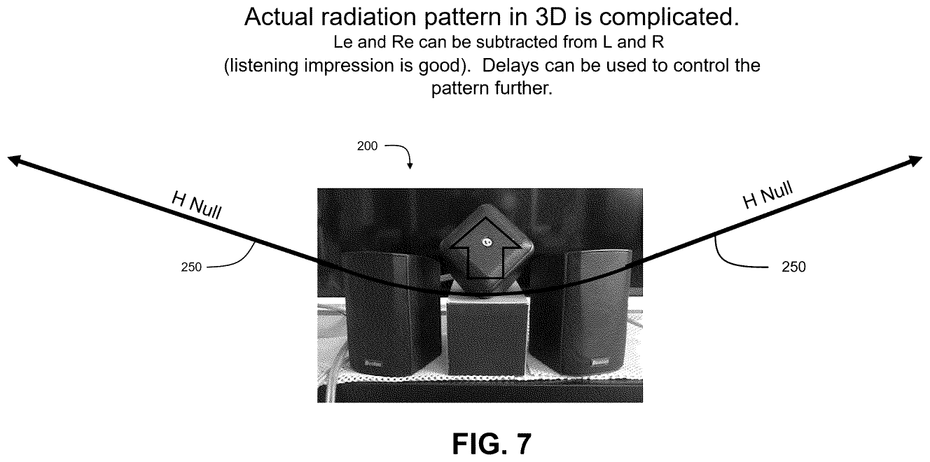

Referring next to FIGS. 3 and 4, these annotated diagrams illustrate a side view of a system having a Center/Height speaker (e.g., 206) and a Left speaker (e.g., 202) (such as corresponding to the C/H and L elements of the L-C/H-R array of FIG. 2). FIGS. 3 and 4 can illustrate the signal processing method for steering a left side null vector to create a Null at the listening location and aiming that null by adjusting delays to create a user-perceived height/elevation (H) content apparent sound source which appears to emanate from the ceiling while preserving user-perceived center (C) content from the Center/Height speaker 206, thereby emphasizing Le/Re/H sound reflected toward the listener from the ceiling. The center channel audio signal C can arrive at the listener before the H signal (e.g., there being no 3 ms delay in the C signal), where the precedence effect experienced by the listener can be strong. In the use-case example of FIG. 3, there is no null for the C signal. As noted above for the embodiment of FIGS. 2 and 7, the left speaker 202 (and the right speaker, not shown in FIGS. 3 and 4) is/are aimed forwardly in a substantially horizontal listening plane aimed at the listening position (not shown), while the center/height speaker 206 is positioned in close proximity, positioned slightly above the L and R speakers (e.g., 3-15 inches above the L and R speakers) and aimed upwardly at a selected acute C/H aiming angle (e.g. 20 to 60 degrees) with respect to that horizontal listening plane.

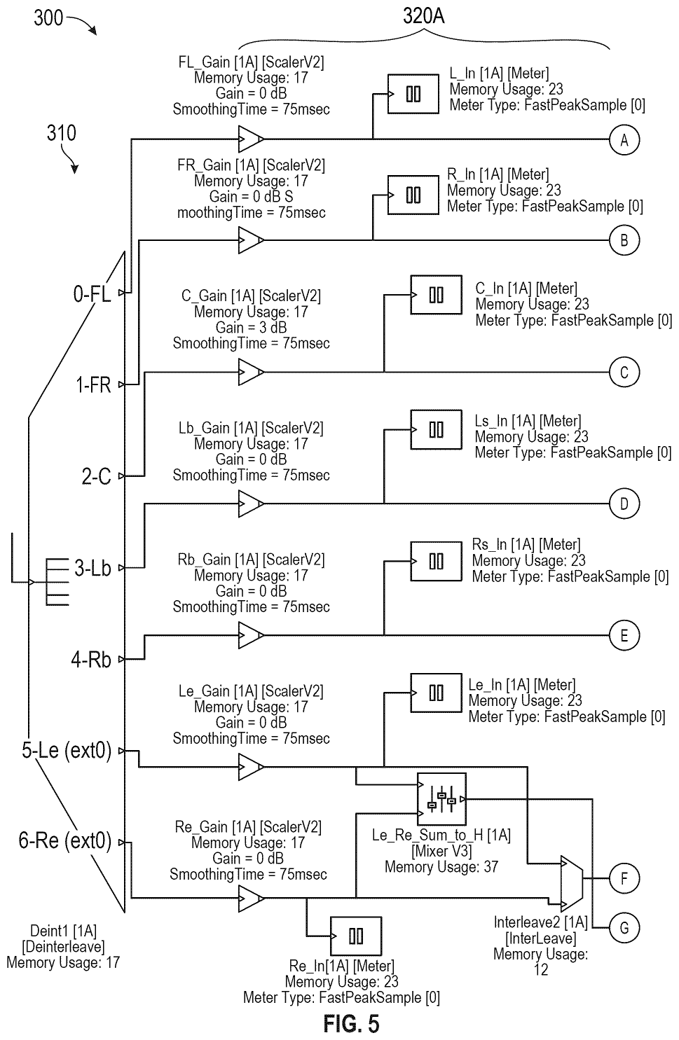

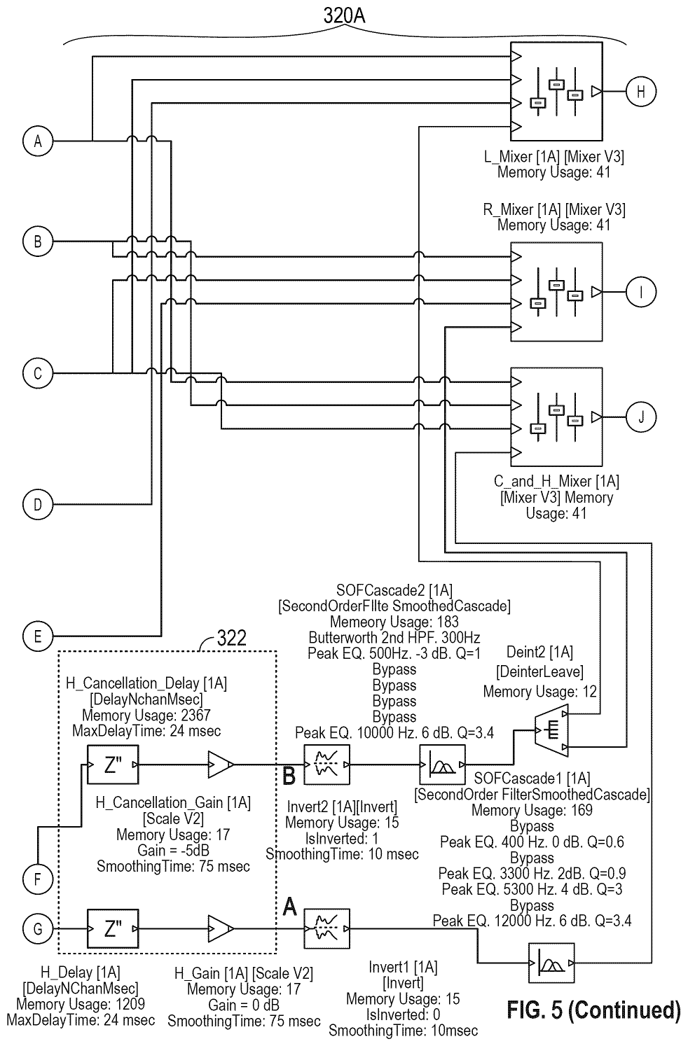

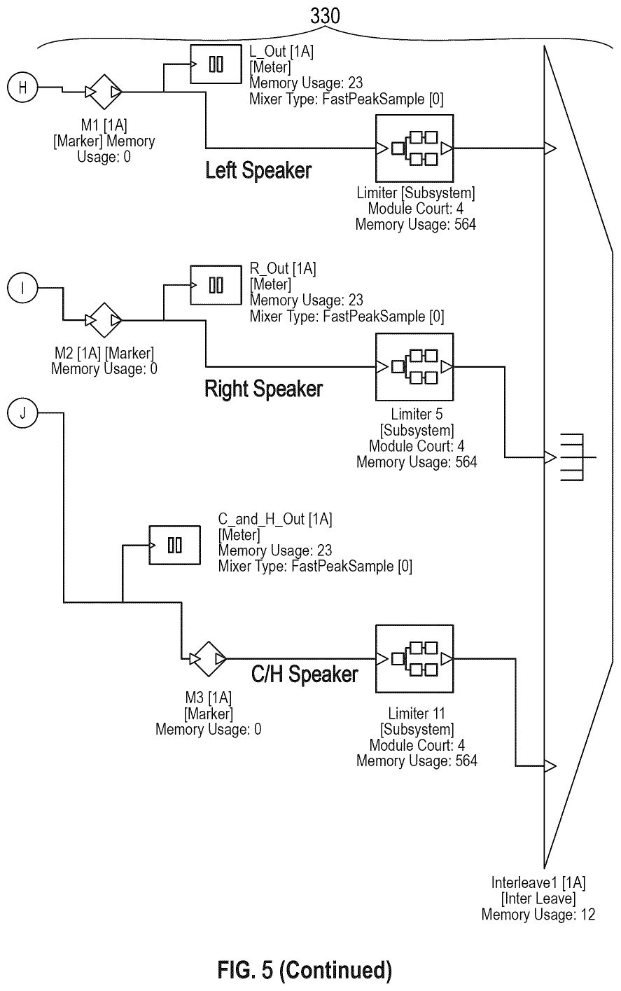

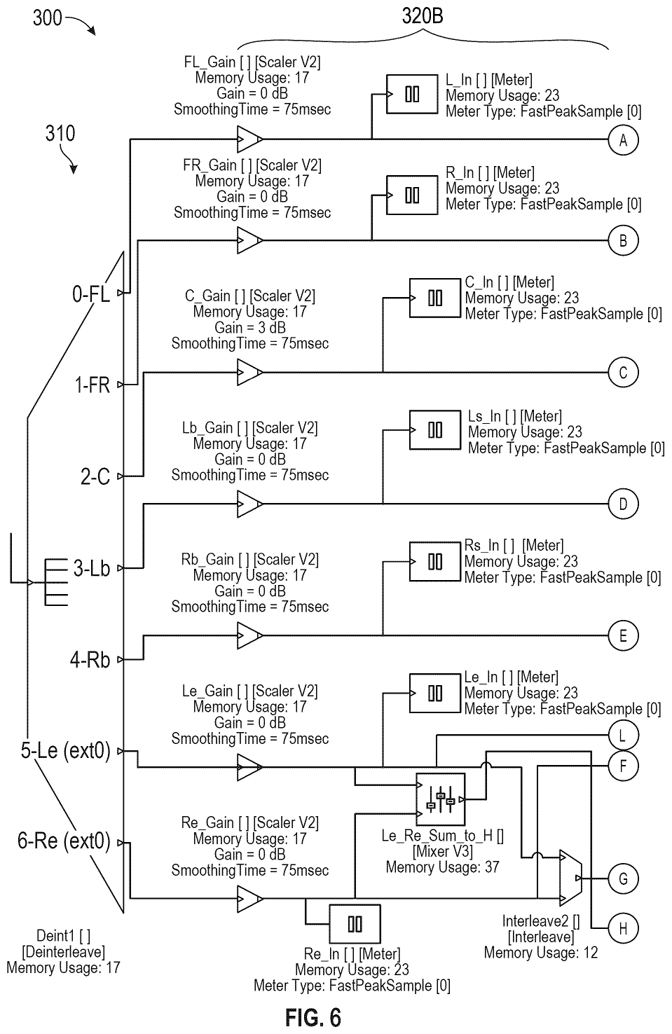

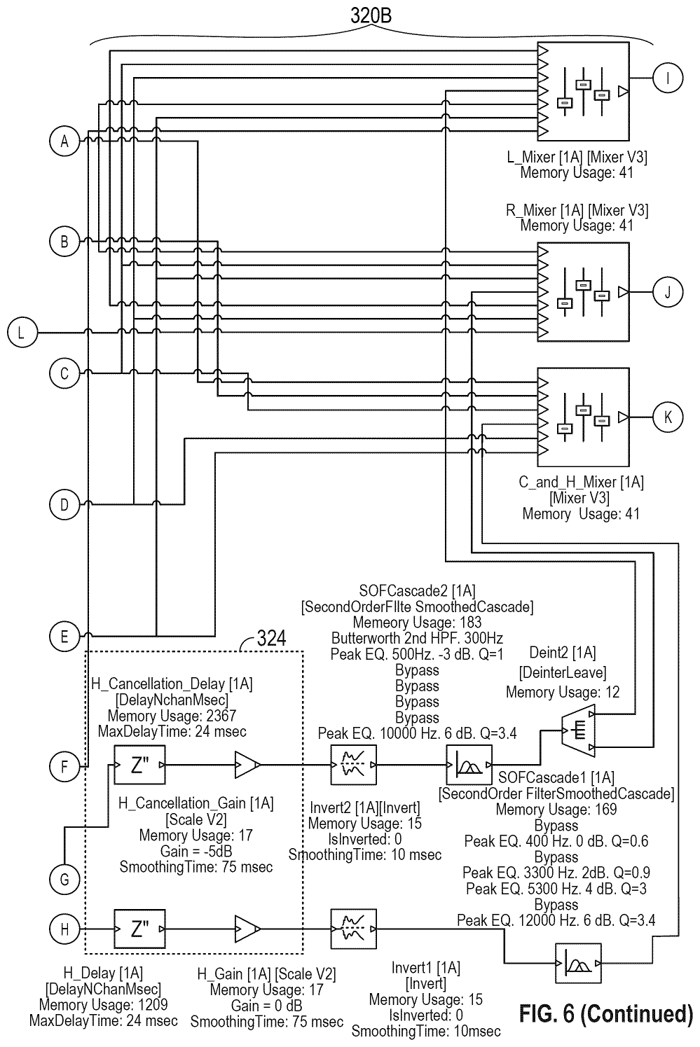

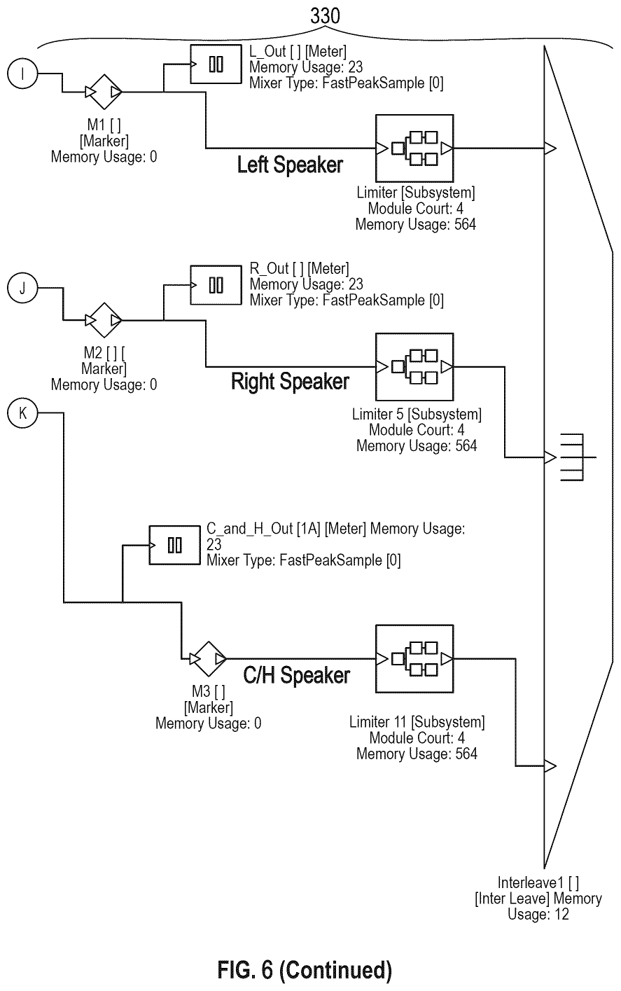

The signal processing method can create the signal flows which achieve the effects described above. Digital signal processing methods may be encoded and Digital Signal Processing (DSP) programs can use tools such as Audio Weaver (“AWE”) and an example DSP program can be represented visually as illustrated in FIGS. 5 and 6.

FIG. 5 is a signal flow diagram illustrating an example signal processing method and signal processor 300 for receiving a plurality (e.g., seven) incoming (e.g., ATMOS™) signals, namely Front Left (L), Front Right (R), Center (C), Left Back (Lb), Right Back (Rb), Left Elevation (Le), and Right Elevation (Re) signals in an input section 310. In some embodiments, a deinterleaver (Deint1) can separate a multichannel input into a plurality of separate (e.g., mono) channels. In some cases the deinterleaver can be omitted. A cancellation-delay section 320A can render those incoming signals into a Left element signal, a Center/Height element signal and a Right element signal, with selected signal modifications and delays applied to selected incoming signals to provide (e.g., from three channel output section 330) an enhanced sweet spot listening experience. The diagram of FIG. 5 is a flow diagram from DSP Concepts' AWE™ screenshot illustrating an embodiment for creating a strong null for H that is especially useful for a first user-selectable mode optimized for sweet spot listening.

A mixer or other signal combiner (e.g., Le_Re_Sum_to_H) can produce a combined (e.g., summed) signal (G) from the Le and Re signals, which can be used to drive the center/height speaker 206 (e.g., with additional signal processing as discussed herein). An interleaver (e.g., Interleave2) or other signal combiner can produce a combined signal (F) from the Le and Re signals, and the individual Le and Re signals can be preserved, so that they can later be divided for driving the left speaker 202 and the right speaker 204. In some embodiments, the Interleave2 module can be omitted and the Le and Re signals can be processed separately and then used to drive the left speaker 202 and the right speaker 204.

Gain modules can optionally be applied to some or all of the seven signals (e.g., FL_Gain, FR_Gain, C_Gain, Lb_Gain, Rb_Gain, Le_Gain, and Re_Gain), such as to adjust the amplitude or intensity of the various signals, such as for fine tuning effects and features discussed herein, or in some cases in response to user input. Meters can optionally measure the seven signals (e.g., L_in, R_in, C_in, Ls_in, Rs_in, Le_in, and Re_in), such as after the gain, which can be used for monitoring, diagnostics, and/or for control of the gain (e.g., using a feedback approach).

In the embodiment of FIG. 5, cancellation-delay section 320A can include module 322 set to receive Left Elevation (Le) and Right Elevation (Re) signals from the input section 310 and, in response to user control inputs in some embodiments, control cancellation delay and/or H delay to aim the null created by cancellation at the listener, as shown. In the sweet spot listening mode illustrated in FIG. 5, as shown in module 322, cancellation delay (e.g., the delay of the-Re and-Le signals (“first case”) or the Re and Le signals (“second case”) used to drive the right speaker 204 and the left speaker 202) can be adjusted or set to be substantially equal to H delay (e.g., the delay of the Re and Le signals (“first case”) or the-Re and-Le signals (“second case”) used to drive the center/height speaker 206), or, optionally, the cancellation delay and/or the H delay can be adjusted to aim the null created by cancellation at the listener.

A user interface (e.g., on the speaker system or on a phone or other control device in communication with the speaker system) can be configured to receive input (e.g., from the listener or other user) and to adjust the cancellation delay and/or the height (H) delay to steer or otherwise move the null, which can effectively move the sweet spot listening location 24. Accordingly, in some embodiments, the audio system can provide user control of the listening location 24. For example, the user interface can include a first input element (e.g., an up button) or can otherwise be configured to receive a first command, and in response the audio system can move the null upward, such as by increasing the amount of the height (H) delay and/or by decreasing the amount of the cancelation delay. The user interface can include a second input element (e.g., a down button) or can otherwise be configured to receive a second command, and in response the audio system can move the null downward, such as by increasing the amount of the cancellation delay and/or by decreasing the amount of the height (H) delay.

In FIG. 5, the H_Delay module can delay the G signal that will be used to drive the center/height driver 206, and the H_Cancellation_Delay module can delay the F signal that will be used to drive the left driver 202 and the right driver 204. Module 322 can include delay and gain elements. The H_Gain module permits adjustment of the amplitude or intensity of the height (H) signal and the H_Cancellation_Gain module permits adjustment of the amplitude or intensity of the cancellation signal(s), which can be used to tune or adjust for the best effect, such as depending on loudspeaker or transducer sensitivity, etc.

The system can include an inverter (Invert1, which is also labeled “A”) that can be used to invert the G signal, so that the-Le and-Re signals (e.g., the sum thereof) can be used to drive the center/height speaker 206. If Invert1 (inverter A) is not used (e.g., set to 0 as shown in FIG. 5), then the Le and Re signals can be used to drive the center/height speaker 206. The system can include an inverter (Invert2, which is also labeled “B”) that can be used to invert the F signal, so that the −Le and −Re signals can be used to drive the left speaker 202 and the right speaker 204 respectively. If Invert2 (inverter B) is not used (e.g., set to 0), then the Le and Re signals can be used to drive the left speaker 202 and the right speaker 204 respectively. The A and B sections of module 322 show Invert1 (“A”) and Invert2 (“B”) phase inversion operations for the Le and Re signals, and to create a strong null, the phase is inverted for either A or B, but not both. Inverting the phase of Le, Re at “A” can work best in certain products, as discussed herein. That said, inverting the phase of Le, Re at “B” may work better in other product configurations or contexts. For nomenclature purposes, one may write Le′=−Le″, Re′=−Re″ which is meant to convey the same basic idea. A phase inversion (“−”) is used to create a null. That can be accomplished at two different areas of the signal flow in FIG. 5.

The system can optionally include one or more filters. For example, the G signal can be filtered (e.g., by SOFCascade1), such as for equalization or other tuning. The F signal can be filtered (e.g., by SOFCascade2), such as for equalization or other tuning. The system can include an deinterleaver (Deint2) that can split the combined F signal into separate left and right signals. In some implementations, the Interleave2 and Deint2 modules can be omitted, and the Le and Re signals can be processed separately (e.g., using separate delay gain, and/or inverter elements).

The system can include a mixer (L_Mixer) or other signal combiner that receives signals based on FL (“A”), C (“C”), Lb (“D”), and Le (the left deinterleaved signal from “F”), and the L_Mixer can output a combined signal H for driving the left speaker 202. The system can include a mixer (R_Mixer) or other signal combiner that receives signals based on FR (“B”), C (“C”), Rb (“E”), and Re (the right deinterleaved signal from “F”), and the R_Mixer can output a combined signal I for driving the right speaker 204. The system can include a mixer (C_Mixer) or other signal combiner that receives signals based on FL (“A”), FR (“B), C (“C”), and Le and Re (summed signal “G”), and the C_Mixer can output a combined signal J for driving the center/height speaker 206. Optionally, meters (L_Out, R_Out, and C_out) can measure the signals for driving the left speaker 202, the right speaker 204, and the center/height speaker 206, such as for monitoring, diagnostics, or feedback systems, etc. In some embodiments, the system can include an interleaver (Interleave1), which can combine the left speaker signal, the right speaker signal, and the center speaker signal, although in some embodiments, the Interleave1 module can be omitted.

FIG. 6 is another signal flow diagram for system 200 and signal processor 300, but illustrates the signal flow for “party mode” or casual listening, with even coverage across the room. Here again, the system 300 receives a plurality (e.g., seven) incoming (e.g., ATMOS™) signals, namely Front Left (L), Front Right (R), Center (C), Left Back (Lb), Right Back (Rb), Left Elevation (Le), and Right Elevation (Re) signals in an input section 310. Then (in cancellation-delay section 320B) the system can render those incoming signals into a Left element signal, a Center/Height element signal, and a right element signal, with selected signal modifications and delays applied to the five incoming signals to provide a different user-selectable experience.

FIG. 6 is also a flow diagram from applicant's DSP Concepts' AWE™ screenshot illustrating an example embodiment for creating a larger listening area with more even coverage that can be better suited to entertaining many listeners, thereby providing a “party mode” user-selectable listening option. In the embodiment of FIG. 6, cancellation-delay section 320B includes module 324 set to receive Left Elevation (Le) and Right Elevation (Re) signals from input section 310 and, in response to user control inputs in some cases, eliminate cancellation delay and adjust or eliminate H delay. In module 324, there is no cancellation of Le and Re. For example, Invert1 and Invert2 can both be set to 0, so that no inversion is performed on the Le and Re signals. In some cases, a delay can be kept on the Le+Re signal going to the left speaker (e.g., 202) and the right speaker (e.g., 204), or the Le+Re signal can be eliminated or ignored. The corresponding signals fed to the left speaker (e.g., 202) and right speaker (e.g., 204) the delay at H_cancellation_Delay effectively becomes LeRe delay instead of cancellation delay, because no inverted Le and Re signals are used. In module 324, for this mode, the H gains can be set lower for balanced sound now without cancellation. In some implementations, for casual listening or even coverage, (a) there is no more cancellation of Le Re, (b) all content can be sent in-phase to all speakers (e.g., L speaker 202, R speaker 204, and C/H speaker 206) to a large degree, and (c) at the extreme, L speaker 202 plays all five signals (L, R, Le, Re and C) at equal levels. As noted herein, there are different product configurations in which the system and method might be employed, so the relative levels for each input signal's component to be sent to each speaker can be refined for each product geometry. While the embodiments of FIGS. 5 and 6 illustrate 7 channel home theater embodiments (e.g., with inputs at 310), the null forming technique is readily adapted for use with a range of decoded or upmixed channel configurations. For example, L, C, R+LFE+Le, Re can be processed to provide a 3.1.2 embodiment, and other configurations (e.g., 5.1.2, 7.1.2, 5.1.1 etc.) could all benefit from the features disclosed herein.

A user interface (e.g., on the audio system or on a phone or other control device in communication with the audio system) can be configured to receive input (e.g., from the listener or other user) and to change the mode of operation in response to the user input. For example, the user can provide input to set the system in a first operating mode, in which the audio system can be configured to optimize a specific listening position 24, which can provide a listening sweet spot, as discussed herein. For example, the audio system can implement signal processing of FIG. 5 to implement the first operating mode. The user can provide input to set the system in a second operating mode, in which the audio system can play the audio more evenly throughout the listening environment, such as in a “party mode.” For example, the system can implement the signal processing of FIG. 6 to implement the second mode of operation.

Many alternatives are possible. In some embodiments, the signal processing can be implemented using digital signal processing, as discussed herein, while in some implementations, analog signal processing components can be used, or any suitable combination thereof. Various features disclosed in FIGS. 5 and 6 can be rearranged or omitted or replaced with other components. For example, FIG. 5 shows Invert1 (A) and Invert2 (B), and in some cases both inverters can be turned on or off. In some embodiments, only one inverter is used (e.g., Invert1 (A) or Invert2 (B)). Various components can be reordered or rearranged. For example, gain and/or delay can be applied before or after a signal is inverted.

The diagram and photograph of FIG. 7 illustrate that system 200 is configured to generate a complicated sound radiation pattern, when understood in 3 dimensions. The H null 250 extends along a pair of outwardly radiating axes 250. A central upwardly projecting sound radiation aligned vertically with C/H speaker 206 is shown as an upward arrow. In the signal processor of system 200, Le and Re signals can be subtracted from both L and R (which gives a good listening impression). As noted above, delays can be used to aim or steer the H nulls to control the radiation pattern further, thereby creating a sense of Height channel sound (“H”) while preserving the Center channel sound (“C”).

The diagrams and tables of FIGS. 8-9C illustrate how the delays to be implemented in the signal processing methods (e.g., as shown in the example DSP signal flow diagrams of FIGS. 5 and 6). Turning initially to FIG. 8, a ceiling reflection delay calculation can use inputs for a selected user's listening space or a typical or target listening space (e.g., such as room 102 in which is placed a system 200 in front of a listening position 24 beneath a ceiling reflection point selected for a phantom sonic image from a ceiling location 104). In the use case illustrated in the diagrams of FIGS. 8, 9A, 9B and 9C five inputs are used, namely, ceiling height “hc, “the user's or listener's head height (at listening position 24) “hh,” the speaker height “hs,” the lateral distance from system 200 to listening position 24 (or the horizontal listening distance) “ld,” and the angle of incidence and reflection at ceiling location 104 “a.” These inputs and the mathematical equations used to calculate distances and delays are shown on the right side of FIG. 8. In this method, inputs for ceiling height “hc, “the user's or listener's head height (at listening position 24) “hh,” the speaker height “hs,” the horizontal listening distance “ld,” are used to calculate the reflected path difference and time of delay, designated elsewhere as “X” in milliseconds (ms). In the example of FIG. 8, this time of delay is determined to be 2.81 ms. For most applications, this delay value, Xms, will likely be in the range of 1.5 to 5.5 ms, depending on user setting preference and room size (see, e.g., other examples of FIGS. 9A-9C). The use of the term “Xms” is not intended to mean that each instance of Xms has the same amount of delay. The delay applied to different signals can vary, as discussed herein, such as for steering the null. The delay can be about 1 ms, about 1.5 ms, about 2 ms, about 2.5 ms, about 3 ms, about 3.5 ms, about 4 ms, about 4.5 ms, about 5 ms, about 5.5 ms, about 6 ms, about 6.5 ms, about 7 ms, about 7.5 ms, or more, or any values or ranges between any of these values.

Returning to FIG. 8, the C/H speaker can be positioned slightly above the L and R speakers (e.g., about 9 inches or 0.23 meters above the L and R speakers) The diagram's side view of the listening space shows the system 200 projecting sound up to the ceiling 104 for reflection down to a listening position 24 with a seated listener or user's ears at a selected height. In the example of FIG. 8, the user's ears are at 1.02 meters or about a 40 inch height and for a system height of 1.25 meters or about 49 inches above the floor (e.g., for a listening distance of about 10 feet). The configuration and equations used to generate the desired delays or phase shifts for the embodiment of FIGS. 8-9C are as follows:
Input Variables:
   hc=ceiling height
   hh=head height (at listening position 24)
   hs=speaker height (for system 200)
   ld=horizontal listening distance
   a=90-(angle of incidence/reflection)
Distance, Path Length and Delay Calculations:

h1=hc-hs (EQ1)

h2=hc-hh (EQ2)

d2/h2=d1/h1 (EQ3)

d2=d1*h2/h1 (EQ4)

d1+d2=ld (EQ5)

d1+(d1*h2/h1)=ld (EQ6)

d1*h1/h1+d1*h2/h1=ld (EQ7)

d1*(h1+h2)/h1=ld (EQ8)

d1=ld*h1/(h1+h2) (EQ9)

d2=ld-d1 (EQ9)

(l1)\hat{ }2=(d1)\hat{ }2+(h1)\hat{ }2 (EQ10)

l1=(d1\hat{ }2+h1\hat{ }2)\hat{ }(1/2) (EQ11)

cos(a)=h1/l1 (EQ12)

a=arccos(h1/l1) (EQ13)

sin(a)=d1/l1 (EQ14)

l1*sin(a)=d1 (EQ15)

l1=d1/sin(a) (EQ16)

sin(a)=d2/l2 (EQ17)

l2*sin(a)=d2 (EQ18)

l2=d2/sin(a) (EQ19)

FIG. 9A comprises a diagram and spreadsheet entries which (along with FIG. 8 and equations 1-19) illustrate and describe the relative positions and orientations for a user whose ears are at about a 47 inch height and for a system height of about 56 inches above the floor (as recommended for a large version of system 200 and a listening distance of about 12 feet). These inputs are to calculate short delay variations of path lengths or distances used to achieve the user selectable sonic effects of the system and method disclosed herein. In the example of FIG. 9A, the time of delay, designated elsewhere as “X” in milliseconds (ms) is determined to be 1.86 ms.

FIG. 9B comprises a diagram and spreadsheet entries which (along with FIG. 8 and equations 1-19) illustrate the relative positions and orientations for a user whose ears are at a reclined 33 inch height and for a system height of about 42 inches above the floor (as recommended for a large version of system 200 and a listening distance of about 9 feet). These inputs are to calculate short delay variations of path lengths or distances used to achieve the user selectable sonic effects of the system and method disclosed herein. In the example of FIG. 9B the time of delay, designated elsewhere as “X” in milliseconds (ms) is determined to be 5.17 ms.

FIG. 9C comprises a diagram and spreadsheet entries which (along with FIG. 8 and equations 1-19) illustrate the relative positions and orientations used to input and calculate variations of path lengths or distances used to achieve desired user selected 2 Channel (“stereo”) sonic effects. In the example of FIG. 9C the time of delay, designated elsewhere as “X” in milliseconds (ms) is determined to be 3.62 ms.

The speaker system can include a housing or enclosure that supports the drivers. The housing or enclosure can orient the drivers as discussed herein. The speaker system can be a sound bar, in some cases. In other embodiments, the speaker system can include passive speakers, which can be driven by an amplifier. The amplifier or other speaker controller can perform the signal processing to generate the signals to driver the passive speakers to implement the features discussed herein. In some embodiments, the right and left passive speakers can be space apart by about 6 inches, about 12 inches, about 18 inches, about 24 inches, about 30 inches, about 36 inches, about 42 inches, about 48 inches, about 60 inches, about 72 inches, about 84 inches, about 96 inches, or more, or any values or ranges between any of these values.

Although various embodiments discussed herein can have a single driver for the left speaker 202, a single driver for the right speaker 204, and a single driver for the center/height speaker, in some embodiments, multiple drivers can be used. For example, the right speaker signal can driver multiple right drivers, the left speaker signal can driver multiple left drivers, and/or the center/height speaker signal can driver multiple center/height drivers.

For example, in some cases different drivers with different frequency ranges can be used. A speaker system can include a right high-range driver (e.g., a tweeter) and a right mid-range driver. The speaker system can include a left high-range driver (e.g., a tweeter) and a left mid-range driver. The speaker system can include a center high-range driver (e.g., a tweeter) and a center mid-range driver. The speaker can send signals to drive the different range drivers, such as based on one or more cutoff frequencies. In some embodiments, multiple drivers of the same frequency range can be driven by the same signals (e.g., two or more center drivers, two or more right drivers, or two or more left drivers).

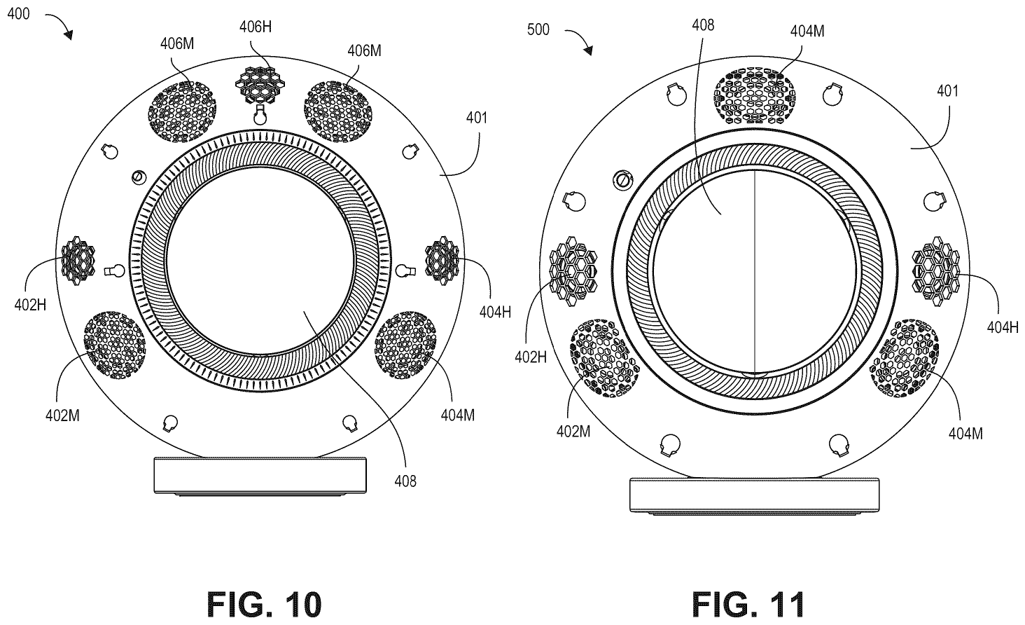

FIG. 10 shows an example embodiments of a speaker system 400 that can be similar to the speaker systems disclosed in U.S. Patent Application Publication No. 2024/0080594, which is incorporated herein by reference. The speaker system 400 can include a housing 401, which can support multiple drivers. The speaker system 400 can include a multiple left drivers, such as a left high-range driver 402H (e.g., a tweeter) and a left driver 402M that has a lower frequency range than the driver 402H. Driver 402M can be a mid-range driver or a full-range driver, for example. The speaker system 400 can include a multiple right drivers, such as a right high-range driver 404H (e.g., a tweeter) and a right driver 404M that has a lower frequency range than the driver 404H. Driver 404M can be a mid-range driver or a full-range driver, for example. The speaker system 400 can include a multiple center/height drivers, such as a center/height high-range driver 406H (e.g., a tweeter) and two center/height drivers 406M that have a lower frequency range than the driver 406H. Drivers 406M can be mid-range drivers or full-range drivers, for example. The speaker system can include a low-range driver of subwoofer 408, which can have a lower frequency range than the high-range or mid-range drivers.

FIG. 11 shows another example embodiment of the speaker system 500, which can be similar to the speaker system 400 of FIG. 10, except as shown and described. The speaker system 500 can include one center/height driver 404M. The example speaker 500 does not include a center/height high-frequency driver 404H. Many variations are possible, and the speaker systems can include one or more of each of the drivers 402H, 402M, 404H, 404M, 406H, 406M, and 408.

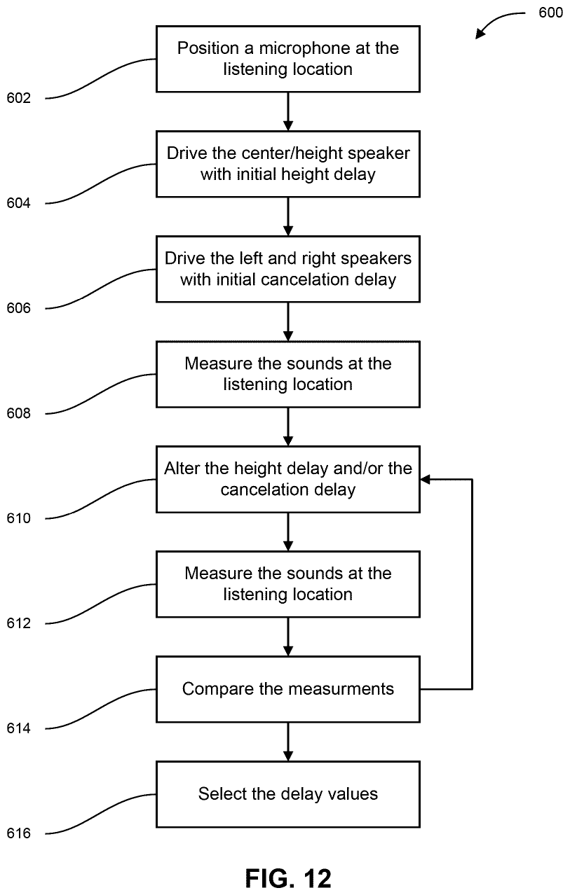

In some embodiments, the audio system can be configured to steer the null automatically. FIG. 12 is a flow chart that shows an example method 600 for steering the null. At block 602 a microphone can be positioned at the listening location 24. The microphone can be on a smartphone or other portable user device, which can be held by a user or positioned on a support at the listening location. The microphone can be in communication with the audio system, such as via a wireless or wired data connection. In some cases, the smartphone or portable user device can provide the microphone information to the audio system, which can perform the analysis and method discussed herein. In some cases, an application on the smartphone or portable user device an perform some or all of the analysis and method and can control the audio system (e.g., to play test tones, etc.).

At block 604 the audio system can drive the center/height speaker based on height signals with an initial height delay. For example, the center/height speaker can be driven using the Le and Re signals, or the −Le and −Re signals, as discussed herein. At block 606, the audio system can drive the left and right speakers with an initial cancellation delay. For example, the left speaker can be driven using the −Le signals or the Le signals, as discussed herein, and the right speaker can be driven using the −Re signals or the Re signals, as discussed herein. Blocks 604 and 606 can be performed at the same time. The sound from the −Re and −Le signals can cancel or attenuate the sound from the Re and Le signals to create a null, as discussed herein.

At block 608, the microphone can measure the direct and indirect sounds at the listening location 24. The listening location 24 may experience some degree of cancellation depending on how close the null is to the listening location 24. At block 610, the audio system can alter the height delay and/or the cancelation delay, which can move the null (e.g., up or down). At block 612, the microphone can measure the sounds at the listening location 24 based on the altered delay values. If altering the delay values moved the null closer to the listening position, the degree of cancellation at the listening location can increase, which can attenuate the direct sound measured by the microphone. If altering the delay values moved the null further from the listening position, the degree of cancellation at the listening location can decrease, which can increase the direct sound measured by the microphone. The system can monitor the sound in the time domain, and can distinguish between the direct sounds that travel directly from the speaker to the microphone (e.g., arriving first in time), and the indirect sounds that bounce off the ceiling and follow an indirect path to the microphone (e.g., which arrive later in time). The system can use test tones that are not stead state (e.g., tone bursts, tone impulses, etc.) so that the direct and indirect sounds can be distinguished. The system can minimize the direct sound using the null, and the system can preserve or enhance the indirect sound (e.g., reflected off the ceiling).

At block 614, the audio system can compare the measurements from the microphone for the different delay values. The system can continue adjusting the delay values and measuring the resulting sounds at the listening location to gather additional data. Eventually, the system can advance to block 616 and the system can select delay values to use during operation, for example based on the collected data and/or the comparisons.

Various different algorithms could be applied by the system to determine how to adjust the delay values and how to select the delay values for operation. By way of example, the system can use the same delay values for the initial height delay at block 604 and the initial cancelation delay at block 606. Then the system can increase the height delay and/or decrease the cancellation delay at block 610, which can move the null upward, for example. The system can compare the measurements and determine whether moving the null upward increased or decreased the cancellation at the listening location. If the cancellation was increased (e.g., the sound was attenuated), the system can continue moving the null upward by increasing the height delay and/or decreasing the cancellation delay. Once moving the null upward causes the cancellation to decrease, the system can determine that the null has moved upward past the listening location, and the system can go back to the delay values with the maximum cancellation. If initially moving the null upward caused the cancellation to decrease (e.g., the sound increased), the system can respond by moving the null downward, such as by increasing the cancellation delay and/or decreasing the height delay. The system, can then move the null downward while the cancellation increases. Once moving the null further downward, the system can determine that the null have moved past the listening location, and the system can go back to the delay values with the maximum cancellations.

In some cases, playing the height and cancellation sounds can produce multiple areas with varying degrees of destructive interference, which can be higher-order nulls, for example. Accordingly, in some situations changing the delay values could move one of the higher-order nulls closer to the listening location, while moving the primary or first-order null away from the listening location. Accordingly, in some implementations, the automated null steering could position the higher-order null at the listening location (e.g., by finding the local maximum of the acoustic cancellation), while the primary or first-order null is at a different location. In some embodiments, the system can sweep through the delay values across an operational range while measuring the resulting sounds. Then, once the delay-time-sweep is complete the system can select the delay values that provided the best results. In some cases, that can be more reliable for placing the primary null at the listening location, and for avoiding optimizing based on higher-order nulls.

In some embodiments, the audio system can play test tones for the automated null positioning process. The test tones can include varying different changing frequencies, impulses, shaped noise signals, or tone bursts.

### Example Embodiments

Embodiment 1. A system 200 for receiving and playing multi-channel audio content in a listening environment, the system comprising:
a signal processor/renderer (e.g., 300) configured to process input audio content and associated meta data specifying a plurality of (e.g., five or more) virtual channels or playback locations of input audio content in a listening environment and generate a smaller plurality (e.g., three) of output audio signals;
a right loudspeaker 204 comprising at least one right driver, the at least one right driver operatively connected to the signal processor/renderer to be driven by at least one first audio signal of the output audio signals, the at least one first audio signal comprising a right-channel main signal and a right-channel elevation-cancellation signal, and/or a combined signal thereof;
a left loudspeaker 202 comprising at least one left driver, the at least one left driver operatively connected to the signal processor/renderer to be driven by at least one second audio signal of the output audio signals, the at least one second audio signal comprising a left-channel main signal and a left-channel elevation-cancellation signal, and/or a combined signal thereof; and
a center/height loudspeaker 206 configured to be positioned between the right loudspeaker and the left loudspeaker, the center/height loudspeaker comprising at least one center/height driver operatively connected to the signal processor/renderer to be driven by at least one third audio signal of the output audio signals, the at least one third audio signal comprising a center main signal and a delayed elevation/height signal derived or rendered from said input audio content.

Embodiment 2. The system of Embodiment 1, wherein said input audio content comprises data from which can be rendered at least one elevation/height (e.g., ATMOS™, DTS-X™ or 360 Reality™) vertical sound channel or vertical envelopment signals (e.g., Le or Re).

Embodiment 3. The system of Embodiment 1, further comprising a user-selectable control input allowing a user to select:
(a) a home theater listening experience with elevation/height (e.g., ATMOS™, DTS-X™ or 360 Reality™) vertical sound envelopment capabilities;
(b) a stereo/music listening experience with elevation/height (e.g., ATMOS™, DTS-X™ or 360 Reality™) vertical sound envelopment capabilities;
(c) a sweet spot stereo/music listening experience without elevation/height (e.g., ATMOS™, DTS-X™ or 360 Reality™) vertical sound envelopment capabilities; or
(d) a party mode stereo/music listening experience with or without elevation/height (e.g., ATMOS™, DTS-X™ or 360 Reality™) vertical sound envelopment capabilities.

Embodiment 4. The system of Embodiment 1, wherein said input audio content includes data corresponding to a left front channel signal (“L”), a left elevation or height channel signal (“Le”), a center channel signal (“C”), a right front channel signal (“R”), and a right elevation or height channel signal (“Re”) (e.g., in an ATMOS™ signal transmission), said system including signal processing circuits programmed to receive those signal and in response, generate:
(a) a Left speaker element signal comprising (L−Le) delayed (e.g., by Xms),
(b) a Right speaker element signal comprising (R−Re) delayed (e.g., by Xms) and
(c) a Center/Height speaker element signal comprising two portions, namely (C (not delayed)) plus a height signal defined as H=(sum Le+Re, delayed (e.g., by Xms)).

Embodiment 5. The system of Embodiment 1, wherein alternative combinations may comprise embodiments in which Speaker 202 plays back [L+(Le′ delayed (e.g., by Xms))]; Speaker 204 plays back [R+(Re′ delayed (e.g., by Xms))]; and Speaker 206 plays back [C+(Le″+Re″ delayed (e.g., by Xms))]; Where Le′=−Le″, Re′=−Re″.

Embodiment 6. The system of Embodiment 4 or 5, whereby said system generates convincing apparent height or elevation sound images above the listener, whereby Height channel signals are played back through the L-C/H-R array (e.g., of system 200 shown in FIGS. 2-4 and 7), without the need to add dedicated elevation or height (H) channel speakers by forming a “null” in vicinity of the listener 24 (or listening position LP) where H content is cancelled, greatly accentuating the sound which seems to come from above (e.g. from a ceiling reflection point 104 selected for a phantom sonic image);
wherein said null is formed by acoustically superimposing projected sounds along a null axis 250, which is aimed by creating selected delays;
wherein, by adjusting the timing of the signals projected from speaker array elements 202, 204, 206 (e.g., the Xms delays), the user selectively controls the aimed angle of a null vector 250, for example in order to get the best effect for their listening setup.

Embodiment 7. The system of Embodiment 4, 5 or 6, wherein left and right speakers (202, 204) are aimed forwardly in a substantially horizontal listening plane (e.g., at about ear level) aimed at the listening position 24 and spaced apart by a selected L-R spacing distance (e.g., 6-18 inches), while the center/height speaker 206 is positioned between them, positioned slightly above the L and R speakers (e.g., 3-15 inches above the L and R speakers) and aimed upwardly at a selected acute C/H aiming angle (e.g. 20 to 60 degrees) with respect to that horizontal listening plane, toward the ceiling at a ceiling reflection point selected for a phantom sonic image from a ceiling location 104.

Embodiment 8. The system of Embodiment 7, wherein, for an all-in-one single enclosure embodiment (e.g., which may superficially resemble smart speaker 120), the preferred spacing is approximately 8 inches.

Embodiment 9. The system of Embodiment 7 or 8, wherein left speaker 202 has it's acoustic center substantially within the substantially horizontal listening plane (e.g., at about ear level) aimed at the listening position 24 and may optionally be toed in (e.g., to aim more directly at listening position 24) or toed out (e.g., as shown in FIG. 2); in a mirror image orientation, right speaker 204 has it's acoustic center substantially within the horizontal listening plane (e.g., at about ear level) aimed at the listening position 24 and may optionally be toed in (e.g., to aim more directly at listening position 24) or toed out, for example as shown; and wherein a selected L-R spacing distance SPLR is defined between the acoustic centers of Left Speaker 202 and Right Speaker 204 (e.g., 6-18 inches), while the center/height speaker 206 is positioned in a substantially centered position between them, positioned slightly above the L and R speakers by a vertical spacing SPCH which is defined between acoustic center of the C/H speaker 206 and the horizontal listening plane (e.g., 3-15 inches above the L and R speakers) and aimed upwardly at a selected acute C/H aiming angle (e.g. 20 to 60 degrees) with respect to that horizontal listening plane.

Embodiment 10. A method for receiving and playing multi-channel audio content in a listening environment, comprising:
receiving input audio content and associated meta data specifying a plurality of (e.g., five) playback locations of the input audio content in the listening environment and in response generating first, second, and third drive signals comprising a left speaker drive signal (L), a right speaker drive signal (R), and a Center/Height drive signal (C/H);
providing a right loudspeaker 204 comprising at least one right driver, the at least one right driver operatively configured be driven by at least one of said first, second, and third drive signals, the at least one of said drive signals comprising a right-channel main signal and a right-channel elevation-cancellation signal, and/or a combined signal thereof;
providing a left loudspeaker 202 comprising at least one left driver, the at least one left driver operatively configured be driven by at least one of said first, second, and third drive signals, the at least one of said drive signals comprising a left-channel main signal and a left-channel elevation-cancellation signal, and/or a combined signal thereof; and
providing a center/height loudspeaker 206 configured to be positioned between the right loudspeaker 204 and the left loudspeaker 202, the center/height loudspeaker comprising at least one center/height driver operatively configured to be driven by said third drive signal comprising a center main signal and a delayed elevation/height signal derived or rendered from said input audio content.

Embodiment 11. The method of Embodiment 10, wherein said input audio content and associated meta data correspond to five playback locations corresponding to five rendered input signals as follows: a left front channel location signal (L), left elevation channel location signal (Le), a center front channel location signal (C), a Right front channel location signal (R), and a right elevation channel location signal (Re), and said first, second, and third drive signals comprising a left speaker drive signal (L), a right speaker drive signal (R), and a Center/Height drive signal (C/H).

Embodiment 12. The method of Embodiment 10 or 11, wherein said first drive signal comprises a left speaker drive signal (L) that is generated by combining (a) a delayed, amplitude adjusted version of said left front channel location signal (L) with (b) a delayed, amplitude adjusted version of said left elevation channel location signal (Le) to generate said left-channel elevation-cancellation signal (see e.g., FIG. 7, Left speaker 202 plays L subtracted by Le, delayed Xms).

Embodiment 13. The method of any one of Embodiments 10 to 12, wherein said second drive signal comprises a right speaker drive signal (R) that is generated by combining (a) a delayed, amplitude adjusted version of said right front channel location signal (R) with (b) a delayed, amplitude adjusted version of said right elevation channel location signal (Re) to generate said left-channel elevation-cancellation signal (see e.g., FIG. 7, Right speaker 204 plays R subtracted by Re, delayed Xms).

Embodiment 14. The method of any one of Embodiments 10 to 13, wherein said third drive signal comprises a Center/Height speaker drive signal (C/H), generated by combining (a) a delayed, amplitude adjusted version of said Center front channel location signal (C) with (b) a delayed, amplitude adjusted version of said right elevation channel location signal (Re) and said left elevation channel location signal (Le) (e.g., to generate said C/H elevation-cancellation signal) (see e.g., FIG. 7, C/H speaker 206 plays C (not delayed) and an H signal which is the sum of Le and Re delayed by Xms (e.g., 1.5 to 5.5 ms, depending on user preference and room size, see FIGS. 8-9C)).

Embodiment 15. The method of Embodiment 10, wherein said first, second, and third drive signals are generated with delays (e.g., “Xms”) selected to create a null at the listening location 24, such as by having audio for C arrive at the listener before H (see, e.g., FIGS. 3 and 4).

### Additional Information

Having described certain embodiments, it is believed that other modifications, variations and changes will be suggested to those skilled in the art in view of the teachings set forth herein. It is therefore to be understood that all such variations, modifications and changes are believed to fall within the scope of the disclosure.

In some embodiments, the methods, techniques, microprocessors, and/or controllers described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination thereof. The instructions can reside in RAM memory, flash memory, ROM memory, EPROM memory, EEPROM memory, registers, hard disk, a removable disk, a CD-ROM, or any other form of a non-transitory computer-readable storage medium. Such special-purpose computing devices may also combine custom hard-wired logic, ASICs, or FPGAs with custom programming to accomplish the techniques. The special-purpose computing devices may be desktop computer systems, server computer systems, portable computer systems, handheld devices, networking devices or any other device or combination of devices that incorporate hard-wired and/or program logic to implement the techniques.

The microprocessors or controllers described herein can be coordinated by operating system software, such as iOS, Android, Chrome OS, Windows XP, Windows Vista, Windows 7, Windows 8, Windows 10, Windows Server, Windows CE, Unix, Linux, SunOS, Solaris, iOS, Blackberry OS, VxWorks, or other compatible operating systems. In other embodiments, the computing device may be controlled by a proprietary operating system. Conventional operating systems control and schedule computer processes for execution, perform memory management, provide file system, networking, I/O services, and provide a user interface functionality, such as a graphical user interface (“GUI”), among other things.

The microprocessors and/or controllers described herein may implement the techniques described herein using customized hard-wired logic, one or more ASICs or FPGAs, firmware and/or program logic which causes microprocessors and/or controllers to be a special-purpose machine. According to one embodiment, parts of the techniques disclosed herein are performed a controller in response to executing one or more sequences instructions contained in a memory. Such instructions may be read into the memory from another storage medium, such as storage device. Execution of the sequences of instructions contained in the memory causes the processor or controller to perform the process steps described herein. In alternative embodiments, hard-wired circuitry may be used in place of or in combination with software instructions.

Moreover, the various illustrative logical blocks and modules described in connection with the embodiments disclosed herein can be implemented or performed by a machine, such as a processor device, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A processor device can be a microprocessor, but in the alternative, the processor device can be a controller, microcontroller, or state machine, combinations of the same, or the like. A processor device can include electrical circuitry configured to process computer-executable instructions. In another embodiment, a processor device includes an FPGA or other programmable device that performs logic operations without processing computer-executable instructions. A processor device can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor device may also include primarily analog components. For example, some or all of the techniques described herein may be implemented in analog circuitry or mixed analog and digital circuitry.

Unless the context clearly requires otherwise, throughout the description and the claims, the words “comprise,” “comprising,” “include,” “including,” and the like are to be construed in an inclusive sense, as opposed to an exclusive or exhaustive sense; that is to say, in the sense of “including, but not limited to. ” The words “coupled” or connected,” as generally used herein, refer to two or more elements that can be either directly connected, or connected by way of one or more intermediate elements. Additionally, the words “herein,” “above,” “below,” and words of similar import, when used in this application, shall refer to this application as a whole and not to any particular portions of this application. Where the context permits, words in the Detailed Description using the singular or plural number can also include the plural or singular number, respectively. The words “or” in reference to a list of two or more items, is intended to cover all of the following interpretations of the word: any of the items in the list, all of the items in the list, and any combination of the items in the list. All numerical values provided herein are intended to include similar values within a range of measurement error.

Although this disclosure contains certain embodiments and examples, it will be understood by those skilled in the art that the scope extends beyond the specifically disclosed embodiments to other alternative embodiments and/or uses and obvious modifications and equivalents thereof. In addition, while several variations of the embodiments have been shown and described in detail, other modifications will be readily apparent to those of skill in the art based upon this disclosure. It is also contemplated that various combinations or sub-combinations of the specific features and aspects of the embodiments may be made and still fall within the scope of this disclosure. It should be understood that various features and aspects of the disclosed embodiments can be combined with, or substituted for, one another in order to form varying modes of the embodiments. Any methods disclosed herein need not be performed in the order recited. Thus, it is intended that the scope should not be limited by the particular embodiments described above.

Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment. Any headings used herein are for the convenience of the reader only and are not meant to limit the scope.

Further, while the devices, systems, and methods described herein may be susceptible to various modifications and alternative forms, specific examples thereof have been shown in the drawings and are herein described in detail. It should be understood, however, that the disclosure is not to be limited to the particular forms or methods disclosed, but, to the contrary, this disclosure covers all modifications, equivalents, and alternatives falling within the spirit and scope of the various implementations described. Further, the disclosure herein of any particular feature, aspect, method, property, characteristic, quality, attribute, element, or the like in connection with an implementation or embodiment can be used in all other implementations or embodiments set forth herein. Any methods disclosed herein need not be performed in the order recited. The methods disclosed herein may include certain actions taken by a practitioner; however, the methods can also include any third-party instruction of those actions, either expressly or by implication.

The ranges disclosed herein also encompass any and all overlap, sub-ranges, and combinations thereof. Language such as “up to,” “at least,” “greater than,” “less than,” “between,” and the like includes the number recited. Numbers preceded by a term such as “about” or “approximately” include the recited numbers and should be interpreted based on the circumstances (e.g., as accurate as reasonably possible under the circumstances, for example ±5%, ±10%, ±15%, etc.). For example, “about 3.5 mm” includes “3.5 mm.” Phrases preceded by a term such as “substantially” include the recited phrase and should be interpreted based on the circumstances (e.g., as much as reasonably possible under the circumstances). For example, “substantially constant” includes “constant. ” Unless stated otherwise, all measurements are at standard conditions including ambient temperature and pressure.

The following is claimed:

1. A loudspeaker system comprising:
a left speaker;
a right speaker;
a center speaker positioned between the left speaker and the right speaker and aimed generally upward; and
a signal processor configured to:
receive a left audio signal (L);
receive a right audio signal (R);
receive a center audio signal (C);
receive a left elevation audio signal (Le);
receive a right elevation audio signal (Re);
generate a left speaker signal that comprises the left audio signal and the left elevation audio signal;
generate a right speaker signal that comprises the right audio signal and the right elevation audio signal;
generate a center speaker signal that comprises the center audio signal, an inverted instance of the left elevation audio signal, and an inverted instance of the right elevation audio signal;
drive the left speaker using the left speaker signal (L+Le);
drive the right speaker using the right speaker signal (R+Re); and
drive the center speaker using the center speaker signal (C−Le−Re).

2. The loudspeaker system of claim 1, wherein the loudspeaker system is configured to use the sounds produced by the left elevation audio signal and the right elevation audio signal to at least partially cancel sounds produced by the inverted instance of the left elevation audio signal and the inverted instance of the right elevation audio signal at a null.

3. The loudspeaker system of claim 2, wherein the signal processor is configured to apply a first delay to the inverted instance of the left elevation audio signal and the inverted instance of the right elevation audio signal that are used to drive the center speaker.

4. The loudspeaker system of claim 3, wherein the signal processor is configured to apply a second delay to the left elevation audio signal used to drive the left speaker and to apply the second delay the right elevation audio signal used to drive the right speaker.

5. The loudspeaker system of claim 4, wherein the signal processor is configured to adjust a relative delay between the first delay and the second delay to move the null.

6. The loudspeaker system of claim 5, wherein the loudspeaker system is configured to receive user input and to adjust the relative delay to move the null based on the user input.

7. The loudspeaker system of claim 5, wherein the loudspeaker system is configured to automatically move the null towards a listening position.

8. The loudspeaker system of claim 1, wherein the loudspeaker system is configured to transition to a different operating mode in which the signal processor is configured to:
drive the left speaker using the left audio signal, the right audio signal, the center audio signal, the left elevation audio signal, and the right elevation audio signal;
drive the right speaker using the left audio signal, the right audio signal, the center audio signal, the left elevation audio signal, and the right elevation audio signal; and
drive the center speaker using the left audio signal, the right audio signal, the center audio signal, the left elevation audio signal, and the right elevation audio signal.

9. The loudspeaker system of claim 8, wherein the loudspeaker system is configured to receive user input and to transition to the different operating mode in response to the user input.

10. The loudspeaker system of claim 1, comprising a housing or enclosure that supports the left speaker, the right speaker, and the center speaker.

11. A method for playing multi-channel audio content in a listening environment, the method comprising:
receiving left audio signals;
receiving right audio signals;
receiving center audio signals;
receiving left elevation audio signals;
receiving right elevation audio signals;
inverting the left and right elevation audio signals to produce inverted left and right elevation audio signals;
generating center combined audio signals using the center audio signals and the inverted left and right elevation audio signals;
generating left combined audio signals using the left audio signals and the left elevation audio signals;
generating right combined audio signals using the right audio signals and the right elevation audio signals;
driving a center loudspeaker using the center combined audio signals, so that sounds produced by the inverted left and right elevation audio signals are directed upward to bounce off the ceiling and approach a listening location from above, and wherein direct sounds produced by the inverted left and right elevation signals travel directly from the center loudspeaker to the listening location; and
driving a left loudspeaker using the left combined audio signals and driving a right loudspeaker using the right combined audio signals, so that sounds produced by the left elevation audio signals and the right elevation audio signals at least partially cancel the direct sounds produced by the inverted left and right elevation audio signals at the listening location.

12. The method of claim 11, comprising applying a first delay to the inverted left and right elevation audio signals used to drive the center loudspeaker.

13. The method of claim 12, comprising applying a second delay to the left elevation audio signals used to drive the left loudspeaker, and applying the second delay to the right elevation audio signals used to drive the right loudspeaker.

14. The method of claim 13, comprising changing the relative delay between the first delay and the second delay to move an area of destructive interference between the sounds produced by the inverted left and right elevation audio signals and the sounds produced by the right elevation audio signals and the left elevation audio signals.

15. The method of claim 14, comprising receiving a user command via a user interface, and changing the relative delay in response to the user command to move the area of destructive interference.

16. The method of claim 14, comprising positioning a microphone at the listening position and adjusting the relative delay based at least in part on sounds measured by the microphone at the listening position.

17. The method of claim 1, comprising transitioning to a different mode of operation, and operating in the different mode of operation by:
driving the left loudspeaker using the left audio signals, the right audio signals, the center audio signals, the left elevation audio signals, and the right elevation audio signals;
driving the right loudspeaker using the left audio signals, the right audio signals, the center audio signals, the left elevation audio signals, and the right elevation audio signals; and
driving the center loudspeaker using the left audio signals, the right audio signals, the center audio signals, the left elevation audio signals, and the right elevation audio signals.

18. The method of claim 17, comprising receiving a user command via a user interface, and transitioning to the different mode of operation in response to the user command.

19. The method of claim 1, wherein the left loudspeaker, the right loudspeaker, and the center loudspeaker are enclosed inside a shared enclosure.

20. A loudspeaker system comprising:
a left speaker;
a right speaker;
a center speaker positioned between the left speaker and the right speaker; and
a signal processor configured to:
receive a left audio signal;
receive a right audio signal;
receive a left elevation audio signal;
receive a right elevation audio signal;
drive the left speaker based at least in part on the left audio signal and the left elevation audio signal;
drive the right speaker based at least in part on the right audio signal and the right elevation audio signal; and
drive the center speaker based at least in part on the left elevation audio signal and the right elevation audio signal.

21. The loudspeaker system of claim 20, wherein the signal processor is configured to receiving a center audio signal and to drive the center speaker based at least in part on the center audio signal.

22. The loudspeaker system of claim 20, wherein the signal processor is a digital signal processor.

23. The loudspeaker system of claim 20, wherein the signal processor is a signal renderer.

24. The loudspeaker system of claim 20, wherein the signal processor is configured to drive the center speaker based at least in part on an inverted signal that is based on the left elevation audio signal and the right elevation audio signal.

25. The loudspeaker system of claim 20, wherein the signal processor is configured to:
combine the left elevation audio signal and the right elevation audio signal into a combined elevation signal;
invert the combined elevation signal to produce an inverted combined elevation signal; and
drive the center speaker based at least in part on the inverted combined elevation signal.

26. The loudspeaker system of claim 20, wherein the signal processor is configured to drive the left speaker based at least in part on an inverted instance of the left elevation audio signal, and to drive the right speaker based at least in part on an inverted instance of the right elevation audio signal.

27. The loudspeaker system of claim 20, wherein the signal processor is configured to:
generate an inverted left elevation audio signal;
generate an inverted right elevation audio signal;
drive the left speaker based at least in part on the inverted left elevation audio signal; and
drive the right speaker based at least in part on the inverted right elevation audio signal.

28. The loudspeaker system of claim 20, wherein the loudspeaker system is configured to use the sounds produced by the left speaker based on the left elevation audio signal and the sounds produced by the right speaker based on the right elevation audio signal to at least partially cancel sounds produced by the center speaker based on the left elevation audio signal and the right elevation audio signal at a null.

29. The loudspeaker system of claim 28, wherein the signal processor is configured to apply a first delay to signals that are provided to the center speaker based on the left elevation audio signal and the right elevation audio signal.

30. The loudspeaker system of claim 29, wherein the signal processor is configured to apply a second delay to signals that are provided to the left speaker based on the left elevation audio signal, and to apply the second delay to signals that are provided to the right speaker based on the right elevation audio signal.

31. The loudspeaker system of claim 30, wherein the signal processor is configured to adjust a relative delay between the first delay and the second delay to move the null.

32. The loudspeaker system of claim 31, wherein the loudspeaker system is configured to receive user input and to adjust the relative delay to move the null based on the user input.

33. The loudspeaker system of claim 31, wherein the loudspeaker system is configured to automatically move the null towards a listening position.

34. The loudspeaker system of claim 20, wherein the loudspeaker system is configured to transition to a different operating mode in which the signal processor is configured to:
drive the left speaker using the left audio signal, the right audio signal, the center audio signal, the left elevation audio signal, and the right elevation audio signal;
drive the right speaker using the left audio signal, the right audio signal, the center audio signal, the left elevation audio signal, and the right elevation audio signal; and
drive the center speaker using the left audio signal, the right audio signal, the center audio signal, the left elevation audio signal, and the right elevation audio signal.

35. The loudspeaker system of claim 34, wherein the loudspeaker system is configured to receive user input and to transition to the different operating mode in response to the user input.

36. A method comprising:
receiving a left audio signal;
receiving a right audio signal;
receiving a left elevation audio signal;
receiving a right elevation audio signal;
generating a combined height audio signal based at least on the left elevation audio signal and the right elevation audio signal;
driving the center loudspeaker based at least in part on the combined height audio signal;
generating a left elevation cancelation audio signal based at least on the left elevation audio signal and a right elevation cancelation audio signal based at least on the right elevation audio signal;
driving a left loudspeaker based at least in part on the left audio signal and the left elevation cancelation audio signal; and
driving a right loudspeaker based at least in part on the right audio signal and the right elevation cancelation audio signal.

37. The method of claim 36, comprising receiving a center audio signal, and driving the center loudspeaker driver based at least in part on the center audio signal.

38. The method of claim 36, wherein the combined height audio signal is an inverted signal that is based on the left elevation audio signal and the right elevation audio signal.

39. The method of claim 36, comprising:
combining the left elevation audio signal and the right elevation audio signal into a combined signal;
invert the combined signal to produce the combined height audio signal.

40. The method of claim 36, wherein the left elevation cancelation audio signal used to drive the left speaker is based at least in part on an inverted instance of the left elevation audio signal.

41. The method of claim 36, comprising:
generating an inverted left elevation audio signal;
generating an inverted right elevation audio signal;
drive the left speaker based at least in part on the inverted left elevation audio signal; and
drive the right speaker based at least in part on the inverted right elevation audio signal.

42. The method of claim 36, wherein sounds produced by the left elevation cancelation audio signal and the right elevation cancelation audio signal at least partially cancel sounds produced by the combined height audio signal to form a null.

43. The method of claim 42, comprising applying a first delay to signals that are provided to the center speaker based on the left elevation audio signal and the right elevation audio signal.

44. The method of claim 43, comprising applying a second delay to signals that are provided to the left speaker based on the left elevation audio signal, and to apply the second delay to signals that are provided to the right speaker based on the right elevation audio signal.

45. The method of claim 44, comprising adjusting a relative delay between the first delay and the second delay to move the null.

46. The method of claim 45, wherein the loudspeaker system is configured to receive user input and to adjust the relative delay to move the null based on the user input.

47. The method of claim 45, wherein the loudspeaker system is configured to automatically move the null towards a listening position.

48. The method of claim 45, comprising positioning a microphone at the listening position and adjusting the relative delay based at least in part on sounds measured by the microphone at the listening position.

49. A computer-readable medium that comprises instructions that can be read by a computer processor to cause the computer processor to:
receive a left audio signal;
receive a right audio signal;
receive a left elevation audio signal;
receive a right elevation audio signal;
generate a combined height audio signal based at least on the left elevation audio signal and the right elevation audio signal;
generate a left elevation cancelation audio signal based at least on the left elevation audio signal and a right elevation cancelation audio signal based at least on the right elevation audio signal;
drive a center loudspeaker based at least in part on the combined height audio signal;
drive a left loudspeaker based at least in part on the left audio signal and the left elevation cancelation audio signal; and
drive a right loudspeaker based at least in part on the right audio signal and the right elevation cancelation audio signal.

50. The computer-readable medium of claim 49, wherein the instructions are configured to cause the computer processor to receive a center audio signal, and drive the center loudspeaker driver based at least in part on the center audio signal.

51. A loudspeaker system comprising:
a left speaker;
a right speaker;
a left elevation speaker aiming generally upward;
a right elevation speaker aiming generally upward;
a signal processor configured to:
receive a left audio signal;
receive a right audio signal;
receive a left elevation audio signal;
receive a right elevation audio signal;
invert the left elevation audio signal to produce an inverted left elevation audio signal;
invert the right elevation audio signal to produce an inverted right elevation audio signal;
drive the left elevation speaker based at least in part on the inverted left elevation audio signal;
drive the right elevation speaker based at least in part on the inverted right elevation audio signal;
drive the left speaker based at least in part on the left audio signal and the left elevation audio signal; and
drive the right speaker based at least in part on the right audio signal and the right elevation audio signal.

52. The loudspeaker system of claim 51, wherein the signal processor is configured to receiving a center audio signal and to drive a center speaker based at least in part on the center audio signal.
